(19) United States
(12) Patent Application Publication
(10) Pub. No.: US 2026/0173031 A1
(43) Pub. Date: Jun. 18, 2026

(54) TRANSMITTING AND RECEIVING SYSTEM INFORMATION CHANGE NOTIFICATION

(71) Applicant: Samsung Electronics Co., Ltd., Suwon-si (KR)

(72) Inventors: Anil Agiwal, McKinney, TX (US); Kyeongin Jeong, Frisco, TX (US)

(21) Appl. No.: 19/411,118

(22) Filed: Dec. 5, 2025

Related U.S. Application Data
(60) Provisional application No. 63/734,837, filed on Dec. 17, 2024.
(60) Provisional application No. 63/745,089, filed on Jan. 14, 2025.
(60) Provisional application No. 63/757,207, filed on Feb. 11, 2025.
(60) Provisional application No. 63/778,727, filed on Mar. 27, 2025.

(51) Int. Cl. H04W 68/00; H04W 68/02; H04W 76/27

(52) U.S. Cl. CPC H04W 68/005; H04W 68/02; H04W 76/27

(57) ABSTRACT

A user equipment (UE) includes a transceiver configured to (i) receive, from a base station (BS), a first paging configuration, and (ii) receive, from the BS, a second paging configuration. The UE also includes a processor operably coupled to the transceiver. The processor is configured to (i) determine a radio resource control (RRC) state of the UE, and (ii) in response to a determination that the RRC state of the UE is RRC_CONNECTED, monitor for a system information (SI) change notification in any paging occasion (PO) in a modification period. The PO in the modification period is determined based on the first paging configuration.

### CROSS-REFERENCE TO RELATED APPLICATION(S) AND CLAIM OF PRIORITY

This application claims priority under 35 U.S.C. § 119(e) to U.S. Provisional Ser. No. 63/734,837 filed on Dec. 17, 2024, U.S. Provisional Ser. No. 63/745,089 filed on Jan. 14, 2025, U.S. Provisional Ser. No. 63/757,207 filed on Feb. 11, 2025, and U.S. Provisional Ser. No. 63/778,727 filed on Mar. 27, 2025. The above-identified provisional patent applications are hereby incorporated by reference in their entirety.

### TECHNICAL FIELD

This disclosure relates generally to wireless networks. More specifically, this disclosure relates to transmitting and receiving system information (SI) change notifications.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for transmitting and receiving SI change notifications.

In one embodiment, a UE is provided. The UE includes a transceiver configured to (i) receive, from a base station (BS), a first paging configuration, and (ii) receive, from the BS, a second paging configuration. The UE also includes a processor operably coupled to the transceiver. The processor is configured to (i) determine a radio resource control (RRC) state of the UE, and (ii) in response to a determination that the RRC state of the UE is RRC_CONNECTED, monitor for a system information (SI) change notification in any paging occasion (PO) in a modification period. The PO in the modification period is determined based on the first paging configuration.

In another embodiment, a method of operating a UE is provided. The method includes (i) receiving, from a BS, a first paging configuration and (ii) receiving, from the BS, a second paging configuration. The method also includes (iii) determining a RRC state of the UE, and (iv) in response to a determination that the RRC state of the UE is RRC_CONNECTED, monitoring for a SI change notification in any PO in a modification period. The PO in the modification period is determined based on the first paging configuration.

In yet another embodiment, a non-transitory computer readable medium embodying a computer program. The computer program includes program code that, when executed by a processor of a device, causes the device to (i) receive, from a BS, a first paging configuration and (ii) receive, from the BS, a second paging configuration. The program code, when executed by the processor of the device, also causes the device to (iii) determine a RRC state of the device, and (iv) in response to a determination that the RRC state of the device is RRC_CONNECTED, monitor for a SI change notification in any PO in a modification period. The PO in the modification period is determined based on the first paging configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4A illustrates an example of distributed paging frames according to embodiments of the present disclosure;

FIG. 4B illustrates an example of bundled paging frames according to embodiments of the present disclosure;

FIG. 5 illustrates an example procedure to transmit and receive an SI change indication and/or PWS notification according to embodiments of the present disclosure;

FIGS. 6A and 6B illustrate an example of a small data transmission procedure in a cell according to embodiments of the present disclosure;

FIGS. 7A and 7B illustrate another example of a small data transmission procedure in a cell according to embodiments of the present disclosure;

FIGS. 8A and 8B illustrate another example of a small data transmission procedure in a cell according to embodiments of the present disclosure;

FIGS. 9A and 9B illustrate another example of a small data transmission procedure in a cell according to embodiments of the present disclosure;

FIG. 10 illustrates another example of a small data transmission procedure in a cell according to embodiments of the present disclosure;

FIG. 11 illustrates another example of a small data transmission procedure in a cell according to embodiments of the present disclosure;

FIG. 12 illustrates another example of a small data transmission procedure in a cell according to embodiments of the present disclosure;

FIG. 13 illustrates another example of a small data transmission procedure in a cell according to embodiments of the present disclosure; and

FIG. 14 illustrates an example method for transmitting and receiving SI change notifications according to embodiments of the present disclosure.

### DETAILED DESCRIPTION

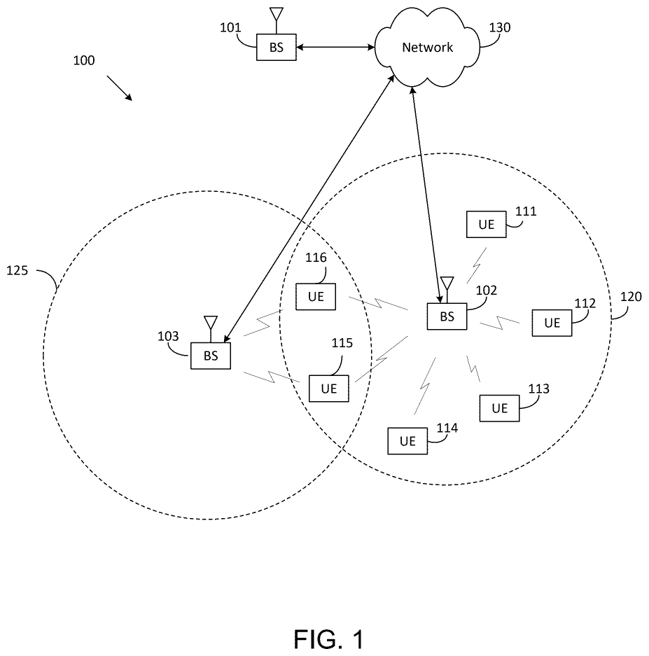

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for transmitting and receiving SI change notifications. In certain embodiments, one or more of the gNBs 101-103 includes circuitry, programing, or a combination thereof, to support transmitting and receiving SI change notifications in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

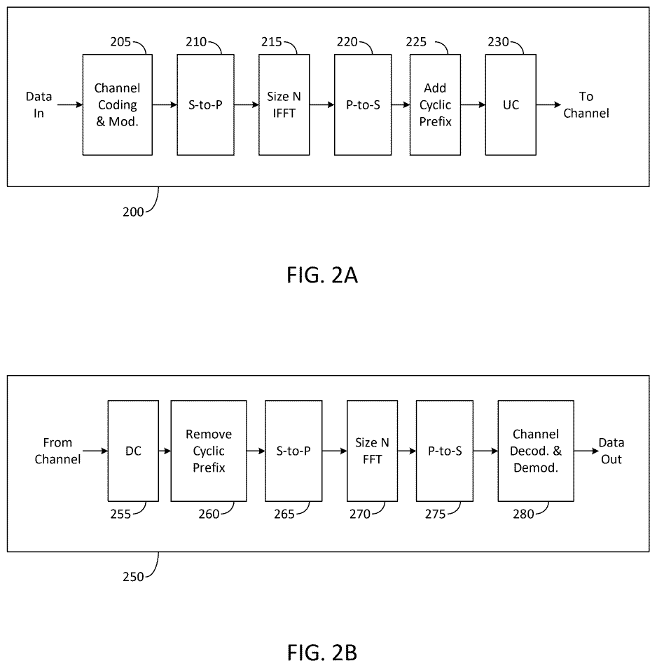

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support transmitting and receiving SI change notifications as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

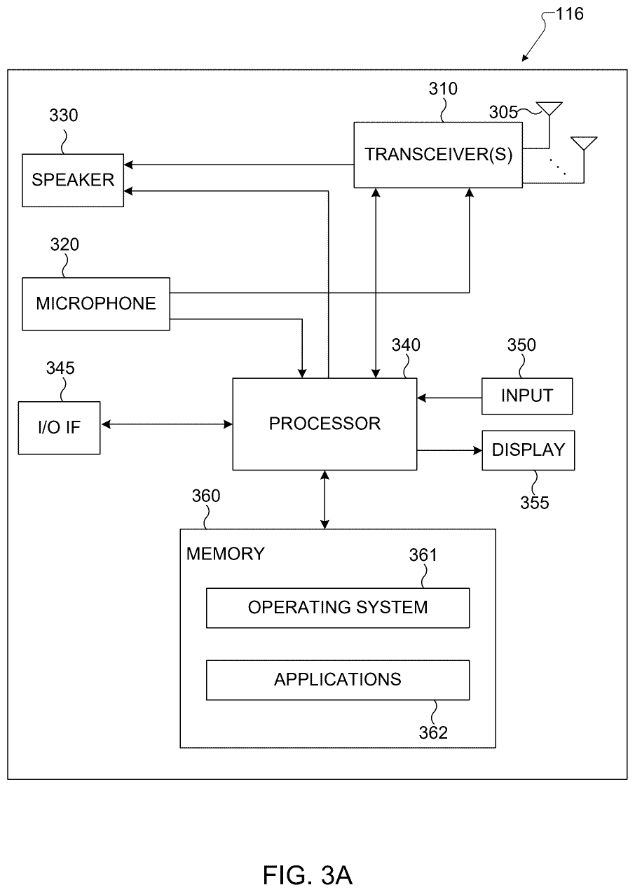

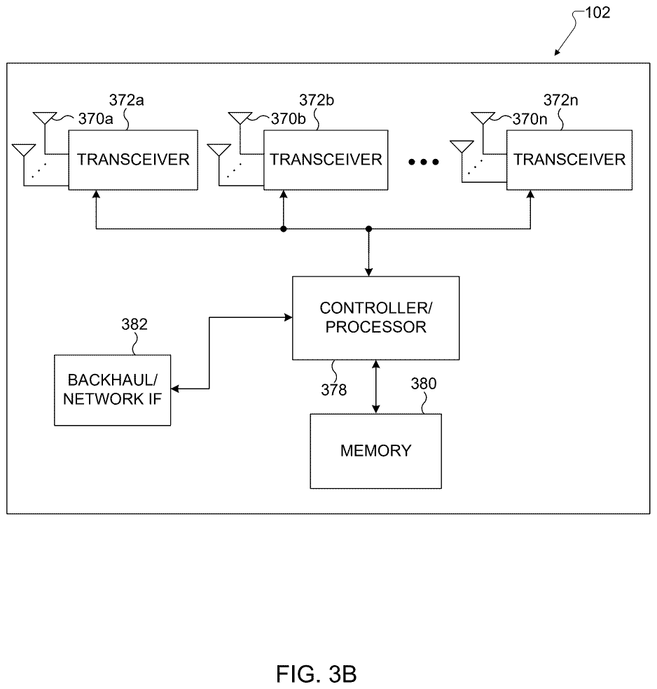

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for transmitting and receiving SI change notifications as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support transmitting and receiving SI change notifications as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC CONNECTED state. Several types of RA procedures are supported, such as contention based random access, and contention free random access. Each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G (B5G), 6G), a UE can be in one of the following RRC states: RRC IDLE, RRC INACTIVE and RRC CONNECTED. Paging allows the network to reach UEs in the RRC_IDLE and in RRC_INACTIVE state through Paging messages, and to notify UEs in the RRC_IDLE, RRC_INACTIVE and RRC_CONNECTED state of system information changes and ETWS (Earthquake and Tsunami Warning System)/CMAS (Commercial Mobile Alert System) indications through Short Messages. Both Paging messages and Short Messages are addressed with a paging radio network terminal identifier (P-RNTI) on the PDCCH, but while the former is sent on a paging common logical channel (PCCH) (a transport block [TB] carrying the paging message is transmitted over the PDSCH [Physical downlink shared channel], the latter is sent over the PDCCH directly.

While in the RRC_IDLE state, the UE monitors the paging channels for core network (CN)-initiated paging. While in the RRC_INACTIVE state, the UE monitors paging channels for radio access network (RAN)-initiated paging and CN-initiated paging. A UE need not monitor paging channels continuously though. Paging discontinuous reception (DRX) is defined where the UE in the RRC_IDLE or RRC_INACTIVE state is only required to monitor paging channels during one Paging Occasion (PO) per DRX cycle.

A PO is a set of PDCCH monitoring occasions and can comprise multiple time slots (e.g., subframes or OFDM symbols) where paging DCI (i.e., PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams, and thus the selection of the beam(s) for the reception of the paging message and Short Message is up to UE implementation. The paging message is the same for both RAN initiated paging and CN initiated paging. The UE initiates the RRC Connection Resume procedure upon receiving RAN initiated paging. If the UE receives a CN initiated paging in the RRC_INACTIVE state, the UE moves to the RRC_IDLE state and informs the network access stratum (NAS).

The PF and PO for paging are determined (by the UE and base station e.g., gNB) by the following formulae:
System frame number (SFN) for the PF is determined by:

$$( SFN + PF\_offset ) mod T = ( T div N ) * ( UE\_ID mod N )$$

Index (i_s), indicating the index of the PO is determined by:

$$i\_s = ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI (or SIB1).

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:
If the UE operates in enhanced DRX (eDRX):
   5G-S-TMSI (5G serving temporary mobile subscriber identity) mod 4096
otherwise:
   5G-S-TMSI Mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and i_s formulas above.

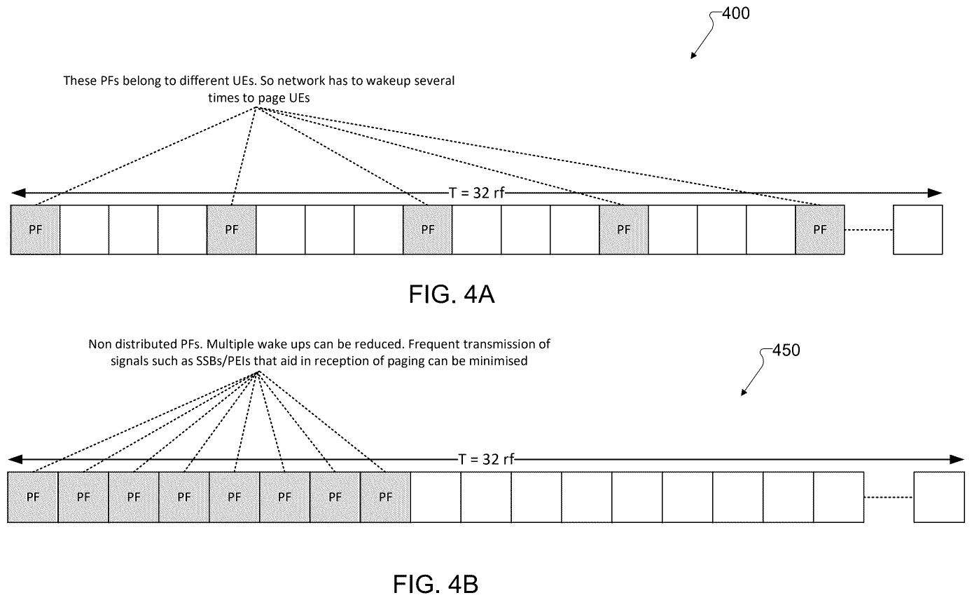

In some embodiments, multiple paging frames configured by the network can be uniformly distributed in time, such as shown in FIG. 4A.

FIG. 4A illustrates an example of distributed paging frames 400 according to embodiments of the present disclosure. The embodiment of distributed paging frames of FIG. 4A is for illustration only. Different embodiments of distributed paging frames could be used without departing from the scope of this disclosure.

In the example of FIG. 4A, POs for UEs are uniformly distributed in time across multiple paging frames. Each UE monitors its PO in its PF every DRX cycle. In the example of FIG. 4A, a PF occurs every 4 radio frames, and there are 4 PFs in each period of 32 radio frames. UEs in the cell are distributed to these PFs based on UE_ID.

Although FIG. 4A illustrates one example of distributed paging frames 400, various changes may be made to FIG. 4A. For example, various changes to the number of paging frames, the frequency of paging frames, etc., could be made according to particular needs.

Distributed PFs such as shown in FIG. 4A leads to frequent wakeup by the network to deliver paging resulting in increased energy consumption. FIG. 4B shows an approach of bundling PFs to reduce multiple wake ups. Frequent transmission of signals such as SSBs/PEIs that aid in reception of paging can also be minimized with bundling.

FIG. 4B illustrates an example of bundled paging frames 450 according to embodiments of the present disclosure. The embodiment of bundled paging frames of FIG. 4B is for illustration only. Different embodiments of bundled paging frames could be used without departing from the scope of this disclosure.

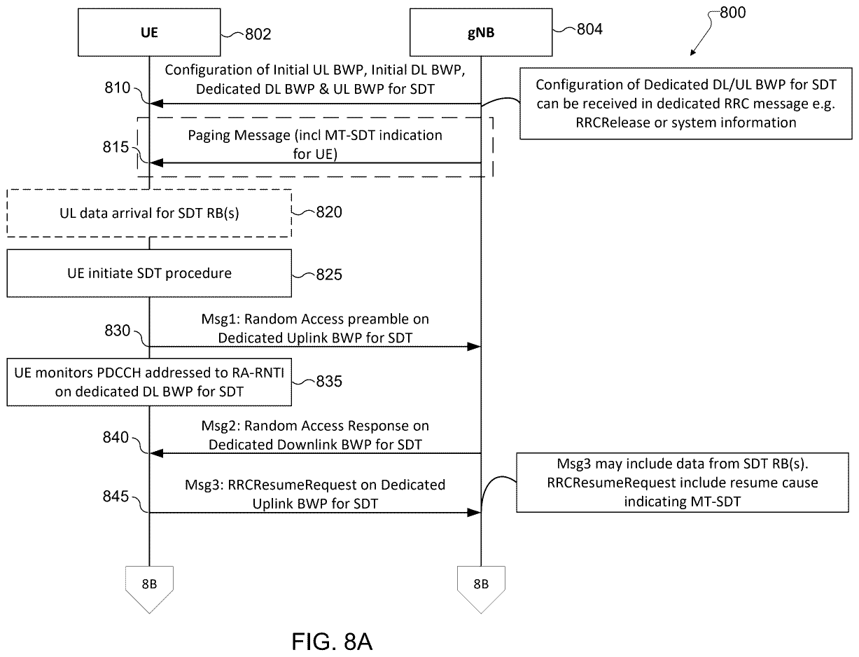

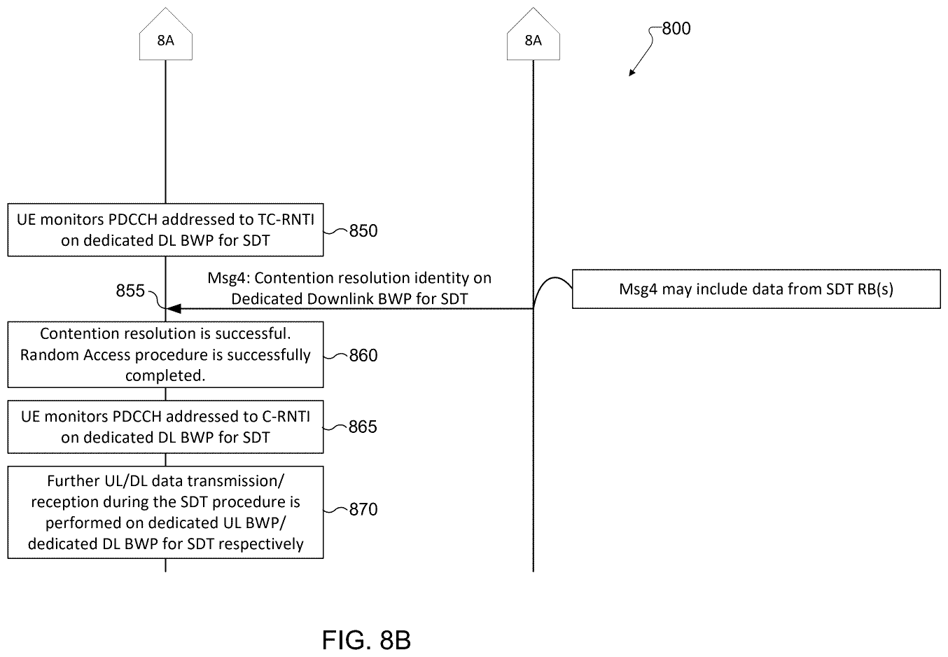

In the example of FIG. 4B, POs for UEs are distributed across multiple paging frames that are bundled together within a period. Each UE monitors its PO in its PF. In the example of FIGS. 4A, 8 consecutive PFs occur at the beginning of each period of 32 radio frames. UEs in the cell are distributed to these PFs based on UE_ID.

For paging adaptation/clustering/bundling a second paging configuration including at least a second value of N and Ns can be signaled by the gNB in system information (e.g., in SIB1). In order to increase the gNB sleeping time, the value of N and Ns in the second paging configuration can configure an increased number of POs per PF with sparser PFs.

Although FIG. 4B illustrates one example of bundled paging frames 450, various changes may be made to FIG. 4B. For example, various changes to the number of paging frames, the frequency of paging frames, etc., could be made according to particular needs.

In some embodiments, a UE monitors for an SI change indication and/or public warning system (PWS) notification in all RRC_states (i.e., RRC_IDLE, RRC_INACTIVE and RRC_CONNECTED) in the active BWP. In embodiments such as these, PF/POs are configured in the cell based on paging configuration 1 and paging configuration 2. Paging configuration 2 is for paging adaptation/clustering/bundling (i.e., for clustered PF/POs at the beginning of DRX cycle). Paging configuration 1 is for distributed PF/POs in a DRX cycle. Various embodiments of the present disclosure indicate which PF/POs are used by an RRC_CONNECTED UE to receive/monitor an SI change indication and/or PWS notification in a cell supporting paging adaptation/clustering/bundling.

In the next generation (e.g., 5G, beyond 5G (B5G), 6G) wireless communication system, mobile originated Small Data Transmission (SDT) is also supported in an RRC_INACTIVE state. SDT is a procedure allowing data and/or signaling transmission while remaining in an RRC_INACTIVE state (i.e., without transitioning to an RRC_CONNECTED state). SDT is enabled on a radio bearer basis and can be initiated either by the UE in the case of MO-SDT (Mobile Originated SDT) or by the network in the case of MT-SDT (Mobile Terminated SDT). MO-SDT is initiated by the UE only if less than or equal to a configured amount of UL data awaits transmission across all radio bearers for which SDT is enabled, the DL RSRP is above a configured threshold, and a valid SDT resource is available. MT-SDT is initiated by the network with an indication to the UE in a paging message when DL data awaits transmission for radio bearers configured for SDT. Based on the indication, the UE initiates the MT-SDT if the DL RSRP is above a configured threshold. When MT-SDT is initiated by the UE, a resume cause indicating MT-SDT is included in the RRCResumeRequest/RRCResumeRequest1. A maximum duration the SDT procedure can last is dictated by a SDT failure detection timer that is configured by the network. The network can enable MO-SDT, MT-SDT, or both in a cell.

SDT procedure is initiated with either a transmission over a random access channel (RACH) (configured via system information) or over Type 1 configured grant (CG) resources (configured via dedicated signaling in RRCRelease). The SDT resources can be configured on the initial BWP for both RACH and CG. RACH and CG resources for SDT can be configured on either or both of NUL and SUL carriers. The CG resources for SDT are valid only within the PCell of the UE when the RRCRelease with suspend indication is received. CG resources are associated with one or multiple SSB(s). For RACH, the network can configure 2-step and/or 4-step RA resources for MO-SDT. When both 2-step and 4-step RA resources for MO-SDT are configured, the UE selects the RA type. If MT-SDT procedure is initiated over RACH, the RACH resources not configured for SDT can be used by the UE. CFRA is not presently supported for SDT over RACH.

Once initiated, the SDT procedure is either:
successfully completed after the UE is directed to RRC_IDLE (via RRCRelease) or to continue in RRC_INACTIVE (via RRCRelease or RRCReject) or to RRC_CONNECTED (via RRCResume or RRCSetup); or
unsuccessfully completed upon cell re-selection, expiry of the SDT failure detection timer, a MAC entity reaching a configured maximum PRACH preamble transmission threshold, an RLC entity reaching a configured maximum retransmission threshold, or integrity check failure while SDT procedure is ongoing, or expiry of SDT-specific timing alignment timer or configuredGrantTimer while SDT procedure is ongoing over CG and the UE has not received a response from the network after the initial PUSCH transmission.

Upon unsuccessful completion of the SDT procedure, the UE transitions to RRC_IDLE.

For SDT, the network should not send an RRCReject in response to RRCResumeRequest/RRCResumeRequest1 if DL data over any radio bearer configured for SDT is transmitted.

The initial PUSCH transmission during the SDT procedure includes at least a common control channel (CCCH) message. When using CG resources for initial SDT transmission, the UE can perform autonomous retransmission of the initial transmission if the UE does not receive confirmation from the network (a dynamic UL grant or DL assignment) before a configured timer expires. After the initial PUSCH transmission, subsequent transmissions are handled differently depending on the type of resource used to initiate the SDT procedure:
When using CG resources, the network can schedule subsequent UL transmissions using dynamic grants or subsequent UL transmissions can take place on the following CG resource occasions. The DL transmissions are scheduled using dynamic assignments. The UE can initiate subsequent UL transmission after reception of confirmation (a dynamic UL grant or DL assignment) for the initial PUSCH transmission from the network. For subsequent UL transmission, the UE does not initiate re-transmission over a CG resource.
When using RACH resources, the network can schedule subsequent UL and DL transmissions using dynamic UL grants and DL assignments, respectively, after the completion of the RA procedure.

When SDT procedure is initiated, access stratum (AS) security is applied for all the radio bearers enabled for SDT.

While the SDT procedure is ongoing, if data appears in a buffer of any radio bearer not enabled for SDT, the UE initiates a transmission of a non-SDT data arrival indication using a UEAssistanceInformation message to the network and, if available, includes the resume cause.

SDT procedure over CG resources can be initiated when UL timing alignment is valid. The UL timing alignment is maintained by the UE based on a SDT-specific timing alignment timer configured by the network via dedicated signaling and, for initial CG-SDT transmission, also by DL RSRP of a configured number of highest ranked SSBs which are above a configured RSRP threshold. Upon expiry of the SDT-specific timing alignment timer, the CG resources are released while maintaining the CG resource configuration.

Logical channel restrictions configured by the network while in an RRC_CONNECTED state and/or in an RRCRelease message for radio bearers enabled for SDT, if any, are applied by the UE during SDT procedure.

The network may configure the UE to apply robust header compression (ROHC) continuity for SDT either when the UE initiates SDT in the PCell of the UE when the RRCRelease with suspend indication was received or when the UE initiates SDT in a cell of its RAN-based notification area (RNA).

For SDT procedure over CG resources, the network may configure a maximum time duration until the next valid CG occasion for initial CG-SDT transmission based on which the UE decides whether SDT procedure over CG resources can be initiated. The maximum time duration is configured per logical channel for MO-SDT and per UE for MT-SDT.

MT-SDT operation over the initial BWP restricts DL data transmissions to the bandwidth of CORESET 0 in the RRC_INACTIVE state. This restriction with no DL quality feedback results in smaller, more conservative transport block (TB) allocations in the downlink at low MCS values. For larger data volumes, a smaller TB size translates to a higher number of subsequent transmissions. Various embodiments of the present disclosure provide for MT-SDT operation for larger data volumes with a reduced number of subsequent transmissions.

As noted above, various embodiments of the present disclosure indicate which PF/POs are used by an RRC_CONNECTED UE to receive/monitor an SI change indication and/or PWS notification in a cell supporting paging adaptation/clustering/bundling.

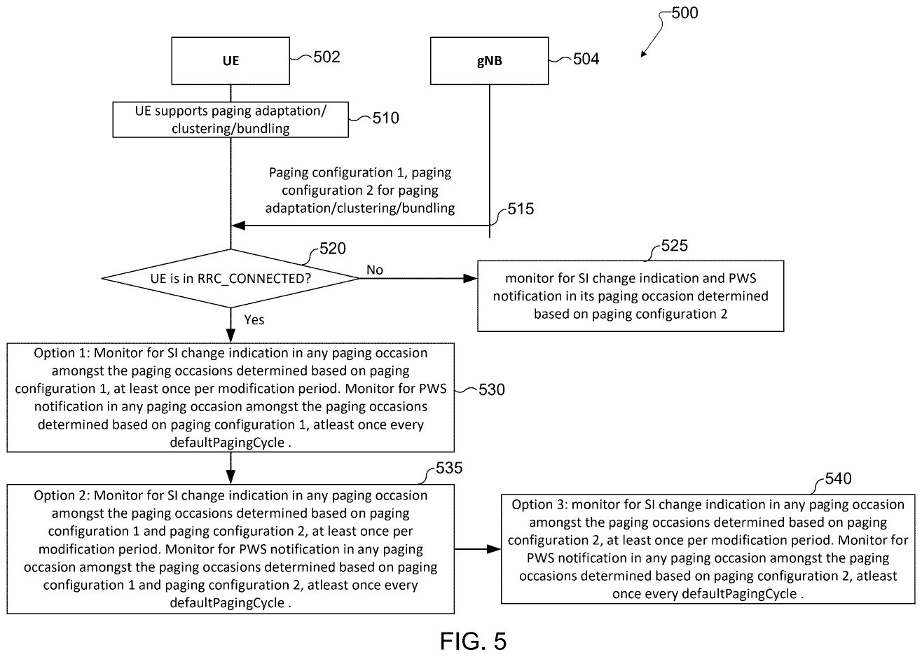

FIG. 5 illustrates an example procedure to transmit and receive an SI change indication and/or PWS notification 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure to transmit and receive an SI change indication and/or PWS notification could be used without departing from the scope of this disclosure.

In the example of FIG. 5, a UE 502 supports paging adaptation/clustering/bundling (block 510). At operation 515, the UE 502 receives a first paging configuration and a second paging configuration from a gNB 504.

In some embodiments, the UE 502 may receive the first paging configuration from the camped cell in the RRC_IDLE/RRC_INACTIVE state or from the PCell in the RRC_CONNECTED state. In embodiments such as these, the first paging configuration is for distributed PF/POs in the DRX cycle. The first paging configuration may include a first value of N (where N=the number of paging frames in a DRX cycle T), a first value of Ns (where Ns=the number of paging occasions per paging frame) and a first value of the paging frame offset. N, Ns and paging frame offset of the first paging configuration can be received in a SIB (e.g., SIB1). The first paging configuration may include a first value of pagingSearchSpace. The first paging configuration may include a parameter firstPDCCH-MonitoringOccasionOfPO, which indicates the first PDCCH monitoring occasion for paging of each PO of the PF. The first paging configuration may include a parameter firstPDCCH-MonitoringOccasionOfPEI-O, which indicates the first PDCCH monitoring occasion of each PEI-O of the PF. The parameters firstPDCCH-MonitoringOccasionOfPO, firstPDCCH-MonitoringOccasionOfPEI-O, and pagingSearchSpace of the first paging configuration can be per BWP and received in a BWP configuration of a BWP. The parameters firstPDCCH-MonitoringOccasionOfPO, firstPDCCH-MonitoringOccasionOfPEI-O, and pagingSearchSpace of the first paging configuration for the initial BWP configuration are received in a SIB (e.g., SIB1). The parameters firstPDCCH-MonitoringOccasionOfPO, firstPDCCH-MonitoringOccasionOfPEI-O, and pagingSearchSpace of the first paging configuration for a BWP other than the initial BWP configuration are received in dedicated RRC signaling.

In some embodiments, the UE 502 may receive a second paging configuration from the camped cell in RRC_IDLE/RRC_INACTIVE state or from the PCell in RRC_CONNECTED state. In embodiments such as these, the second paging configuration is for paging adaptation/clustering/bundling (i.e., for clustered PF/POs at the beginning of a DRX cycle). The second paging configuration may include a second value of N (where N=the number of paging frames in a DRX cycle T), a second value of Ns (where Ns=the number of paging occasions per paging frame), and a second value of the paging frame offset. N, Ns and the paging frame offset of the second paging configuration can be received in a SIB (e.g., SIB1). In some embodiments, the paging frame offset is common for both the first paging configuration and the second paging configuration and is not signaled in the second paging configuration. The second paging configuration may include a parameter firstPDCCH-MonitoringOccasionOfPO, which indicates the first PDCCH monitoring occasion for paging of each PO of the PF). The second paging configuration may include a paramater firstPDCCH-MonitoringOccasionOfPEI-O, that indicates the first PDCCH monitoring occasion of each PEI-O of the PF. The second paging configuration may include a second value of the parameter pagingSearchSpace. In some embodiments, the second paging configuration is signaled only in SIB1 or the second paging configuration is signaled only for an initial downlink BWP. In some embodiments, the parameters firstPDCCH-MonitoringOccasionOfPO, firstPDCCH-MonitoringOccasionOfPEI-O, and pagingSearchSpace of the second paging configuration can be per BWP and received in a BWP configuration of a BWP. The parameters firstPDCCH-MonitoringOccasionOfPO, firstPDCCH-MonitoringOccasionOfPEI-O, and pagingSearchSpace of the second paging configuration for the initial BWP configuration are received in a SIB (e.g., SIB1). The parameters firstPDCCH-MonitoringOccasionOfPO, firstPDCCH-MonitoringOccasionOfPEI-O, and pagingSearchSpace of the second paging configuration for the BWP other than the initial BWP configuration are received in dedicated RRC signaling.

At operation 520, the UE 502 determines whether the use is in an RRC_CONNECTED state. If the UE 502 determines that the UE 502 is not in an RRC_CONNECTED state, the procedure proceeds to operation 525. Otherwise, if the UE 502 determines that the UE is in an RRC_CONNECTED state, the procedure proceeds to the operation of blocks 530-540.

At operation 525, if the UE 502 is not in an RRC_CONNECTED state, the UE 502 monitors for an SI change indication and/or a PWS notification in UE 502's paging occasion determined based on paging configuration 2 (or UE 502 monitors paging based on paging configuration 2) In other words, UE 502 applies N, Ns (and PF_offset, firstPDCCH-MonitoringOccasionOfPO) from paging configuration 2 to determine a PF and PO index, where:
The system frame number (SFN) for the PF is determined by: (SFN+PF_offset) mod T=(T div N)*(UE_ID mod N) where T=min (T1 (if configured), T2 (if configured) and T3 (default DRX cycle)) or T3 or max (T1 (if configured), T2 (if configured), T3 (default DRX cycle)). T1 and T2 are UE specific DRX cycles configured by the NAS and RRC respectively.
Index (i_s), indicating the index of the PO is determined by: i_s=floor (UE_ID/N) mod Ns

At the operations of blocks 530-540, if UE is in RRC_CONNECTED state:
Option 1 (block 530): in some embodiments, the UE 502 monitors for an SI change indication in any paging occasion amongst the paging occasions determined based on paging configuration 1, at least once per modification period. If UE 502 is an ETWS or CMAS capable UE, UE 502 also monitors for a PWS notification in any paging occasion amongst the paging occasions determined based on paging configuration 1, at least once every defaultPagingCycle.
   Alternatively, in some embodiments, the UE 502 monitors for an SI change indication in any paging occasion amongst the paging occasions determined based on paging configuration 1, at least once per modification period if the UE 502 is provided (i.e., signaled by gNB 504) with a common search space, including the parameters pagingsearchspace, searchSpaceSIB1 and searchSpaceOtherSystemInformation (or including pagingSearchSpace), on the active BWP to monitor paging. If the UE 502 is a ETWS or CMAS capable UE, UE 502 monitors for a PWS notification in any paging occasion amongst the paging occasions determined based on paging configuration 1, at least once every defaultPagingCycle if the UE 502 is provided with common search space, including pagingSearchSpace, searchSpaceSIB1 and searchSpaceOtherSystemInformation (or including pagingSearchSpace), on the active BWP to monitor paging.
   The advantage of this procedure is that the network does not need to transmit an SI change indication and/or PWS notification in PF/POs configured for clustered/bundled/adaptive paging in BWPs other than an initial downlink BWP. The network also does not need to signal a BWP specific configuration for clustered/bundled/adaptive paging.
Option 2 (block 535): in some embodiments, the UE 502 monitors for an SI change indication in any paging occasion amongst the paging occasions determined based on paging configuration 1 and paging configuration 2 (if configured), at least once per modification period. If UE 502 is an ETWS or CMAS capable UE, UE 502 also monitors for a PWS notification in any paging occasion amongst the paging occasions determined based on paging configuration 1 and paging configuration 2 (if configured), at least once every defaultPagingCycle.
   Alternatively, in some embodiments, the UE 502 monitors for an SI change indication in any paging occasion amongst the paging occasions determined based on paging configuration 1 and paging configuration 2 (if configured), at least once per modification period if the UE is provided (i.e., signalled by gNB) with a common search space, including pagingSearchSpace, searchSpaceSIB1 and searchSpaceOtherSystemInformation (or including pagingSearchSpace), on the active BWP to monitor paging. If the UE is an ETWS or CMAS capable UE, the UE 502 monitors for a PWS notification in any paging occasion amongst the paging occasions determined based on paging configuration 1 and paging configuration 2 (if configured), at least once every defaultPagingCycle if the UE 502 is provided (i.e., signalled by the gNB 504) with a common search space, including pagingSearchSpace, searchSpaceSIB1 and searchSpaceOtherSystemInformation (or including pagingSearchSpace), on the active BWP to monitor paging.
   The advantage of this procedure is more flexibility to choose a PO for SI change indication and PWS notification.
Option 3 (block 540): In some embodiments, the UE 502 monitors for an SI change indication in any paging occasion amongst the paging occasions determined based on paging configuration 2, at least once per modification period. If the UE 502 is an ETWS or CMAS capable UE 502 monitors for a PWS notification in any paging occasion amongst the paging occasions determined based on paging configuration 2, at least once every defaultPagingCycle.
   Alternatively, in some other embodiments, the UE 502 monitors for an SI change indication in any paging occasion amongst the paging occasions determined based on paging configuration 2, at least once per modification period if the UE 502 is provided (i.e., signalled by the gNB 504) with a common search space, including pagingSearchSpace, searchSpaceSIB1 and searchSpaceOtherSystemInformation (or including pagingSearchSpace), on the active BWP to monitor paging. If the UE 502 (ETWS or CMAS capable UE) monitors for PWS notification in any paging occasion amongst the paging occasions determined based on paging configuration 2, at least once every defaultPagingCycle if the UE 502 is provided (i.e., signalled by gNB 504) with a common search space, including pagingSearchSpace, searchSpaceSIB1 and searchSpaceOtherSystemInformation (or including pagingSearchSpace), on the active BWP to monitor paging.
   The advantage of this procedure is simpler UE implementation as the UE applies the same paging configuration in all RRC states.

In some embodiments, if the UE 502 is not in an RRC_CONNECTED state, the UE 502 monitors paging based on paging configuration 2.

In some embodiments, the gNB 504 transmits an SI change indication and/or PWS notification in the initial downlink BWP in POs configured by the first paging configuration and second paging configuration. In some embodiments, the gNB 504 transmits an SI change indication and/or PWS notification in the DL BWP(s) other than the initial downlink BWP, in POs configured by the first paging configuration.

In some embodiments, the gNB 504 transmits an SI change indication and/or PWS notification in a DL BWP in POs configured by the second paging configuration if the second paging configuration is applicable. The second paging configuration can be applicable if the second paging configuration is configured and/or a BWP specific configuration (if any) for the second paging configuration is signaled for the DL BWP.

In some embodiments, where UE 502 not in an RRC_CONNECTED state (i.e., UE 502 is in RRC_IDLE or UE 502 is in RRC_INACTIVE state) while an SDT procedure is not ongoing, the UE 502 monitors for an SI change indication and/or a PWS notification in its paging occasion determined based on paging configuration 2 (or UE 502 monitors paging based on paging configuration 2). In other words, the UE 502 applies N, Ns (and PF_offset, firstPDCCH-MonitoringOccasionOfPO) from paging configuration 2 to determine PF and PO index, where:
The system frame number (SFN) for the PF is determined by: (SFN+PF_offset) mod T=(T div N)*(UE_ID mod N) where T=min (T1 (if configured), T2 (if configured) and T3 (default DRX cycle)) or T3 or max (T1 (if configured), T2 (if configured), T3(default DRX cycle)). T1 and T2 are UE specific DRX cycles configured by NAS and RRC respectively.
Index (i_s), indicating the index of the PO is determined by: i_s=floor (UE_ID/N) mod Ns.

In some embodiments, where the UE 502 is in an RRC_INACTIVE state while an SDT procedure is ongoing:
if T319a is not running and if CG-SDT is selected and if extended CG-SDT periodicity is configured (i.e., cg-SDT-PeriodicityExt is configured), the UE 502 monitors for and SI change indication and/or PWS notification in UE 502s paging occasion determined based on paging configuration 2 (or UE 502 monitors paging based on paging configuration 2). In other words, UE apply N, Ns (and PF_offset) from paging configuration 2 to determine PF and PO index were:
   The system frame number (SFN) for the PF is determined by: (SFN+PF_offset) mod T=(T div N)*(UE_ID mod N) where T=min (T1 (if configured), T2 (if configured) and T3 (default DRX cycle)) or T3 or max (T1(if configured), T2(if configured), T3 (default DRX cycle)). T1 and T2 are UE specific DRX cycles configured by NAS and RRC respectively.
   Index (i_s), indicating the index of the PO is determined by: i_s=floor (UE_ID/N) mod Ns
Otherwise (in other cases such as T319a is running or if CG-SDT is not selected or extended CG-SDT periodicity is not configured):
   In some embodiments, UE 502 monitors for an SI change indication in any paging occasion amongst the paging occasions determined based on paging configuration 1, at least once per modification period if the initial downlink BWP on which the SDT procedure is ongoing is associated with a CD-SSB. If UE 502 is an ETWS or CMAS capable UE, then UE 502 monitors for a PWS notification in any paging occasion amongst the paging occasions determined based on paging configuration 1, at least once every defaultPagingCycle if the initial downlink BWP on which the SDT procedure is ongoing is associated with a CD-SSB.
   Alternatively, in some embodiments, UE 502 monitors for an SI change indication in any paging occasion amongst the paging occasions determined based on paging configuration 1 and paging configuration 2 (if configured), at least once per modification period if the initial downlink BWP on which the SDT procedure is ongoing is associated with a CD-SSB. If UE 502 is an ETWS or CMAS capable UE, then UE 502 monitors for a PWS notification in any paging occasion amongst the paging occasions determined based on paging configuration 1 and paging configuration 2 (if configured), at least once every defaultPagingCycle if the initial downlink BWP on which the SDT procedure is ongoing is associated with a CD-SSB.
   Alternatively, in some embodiments, UE 502 monitors for an SI change indication in any paging occasion amongst the paging occasions determined based on paging configuration 2, at least once per modification period if the initial downlink BWP on which the SDT procedure is ongoing is associated with a CD-SSB. If UE 502 is an ETWS or CMAS capable UE, the UE 502 monitors for a PWS notification in any paging occasion amongst the paging occasions determined based on paging configuration 2, at least once every defaultPagingCycle if the initial downlink BWP on which the SDT procedure is ongoing is associated with a CD-SSB.

In some embodiments, if UE 502 is in an RRC_CONNECTED state and the active DL BWP is the initial downlink BWP; or if UE 502 is in an RRC_CONNECTED state and a second paging configuration is applicable (the second paging configuration can be applicable if the second paging configuration is configured and/or a BWP specific configuration (if any) for a second paging configuration is signaled) for the active DL BWP:
In some embodiments, UE 502 monitors for an SI change indication in any paging occasion amongst the paging occasions determined based on paging configuration 1 and paging configuration 2 (if configured), at least once per modification period. If UE 502 is an ETWS or CMAS capable UE, then UE 502 monitors for a PWS notification in any paging occasion amongst the paging occasions determined based on paging configuration 1 and paging configuration 2 (if configured), at least once every defaultPagingCycle.
Alternatively, in some embodiments, UE 502 monitors for an SI change indication in any paging occasion amongst the paging occasions determined based on paging configuration 1 and paging configuration 2 (if configured), at least once per modification period if the UE 502 is provided (i.e., signalled by the gNB 504) with a common search space, including pagingSearchSpace, searchSpaceSIB1 and searchSpaceOtherSystemInformation (or including pagingSearchSpace), on the active BWP to monitor paging. If the UE 502 is an ETWS or CMAS capable UE, then the UE 502 monitors for a PWS notification in any paging occasion amongst the paging occasions determined based on paging configuration 1 and paging configuration 2 (if configured), at least once every defaultPagingCycle if the UE 502 is provided (i.e., signalled by the gNB 504) with a common search space, including pagingSearchSpace, searchSpaceSIB1 and searchSpaceOtherSystemInformation (or including pagingSearchSpace), on the active BWP to monitor paging.

In some embodiments, if UE 502 is in an RRC_CONNECTED state and the active DL BWP is the initial downlink BWP; or if UE 502 is in an RRC_CONNECTED state and the second paging configuration is applicable (the second paging configuration can be applicable if the second paging configuration is configured and/or a BWP specific configuration (if any) for the second paging configuration is signaled) for the active DL BWP:
In some embodiments, the UE 502 monitors for an SI change indication in any paging occasion amongst the paging occasions determined based on paging configuration 2, at least once per modification period. If UE 502 is an ETWS or CMAS capable UE, then the UE 502 monitors for a PWS notification in any paging occasion amongst the paging occasions determined based on paging configuration 2, at least once every defaultPagingCycle.
Alternatively, in some embodiments, UE 502 monitors for an SI change indication in any paging occasion amongst the paging occasions determined based on paging configuration 2, at least once per modification period if the UE 502 is provided (i.e., signaled by the gNB 504) with a common search space, including pagingSearchSpace, searchSpaceSIB1 and searchSpaceOtherSystemInformation (or including a pagingSearchSpace), on the active BWP to monitor paging. If UE 502 is an ETWS or CMAS capable UE, then UE 502 monitors for a PWS notification in any paging occasion amongst the paging occasions determined based on paging configuration 2, at least once every defaultPagingCycle if the UE 502 is provided (i.e., signaled by the gNB 504) with a common search space, including pagingSearchSpace, searchSpaceSIB1 and searchSpaceOtherSystemInformation (or including a pagingSearchSpace), on the active BWP to monitor paging.

Although FIG. 5 illustrates one example procedure to transmit and receive an SI change indication and/or PWS notification 500, various changes may be made to FIG. 5. For example, while shown as a series of operations, various operations in FIG. 5 could overlap, occur in parallel, occur in a different order, occur any number of times, be omitted, or replaced by other operations.

As noted above, various embodiments of the present disclosure provide for MT-SDT operation for larger data volumes with a reduced number of subsequent transmissions.

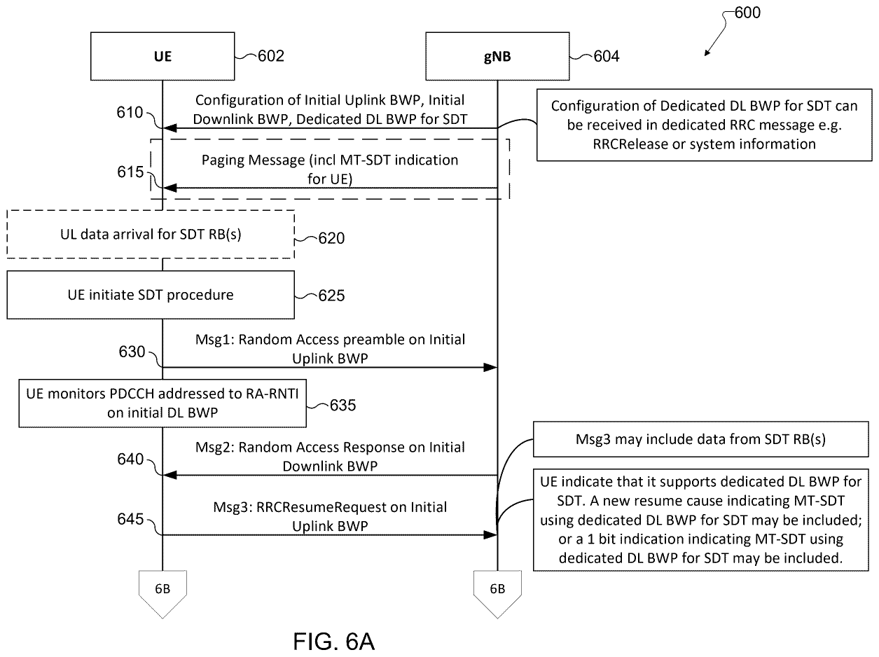

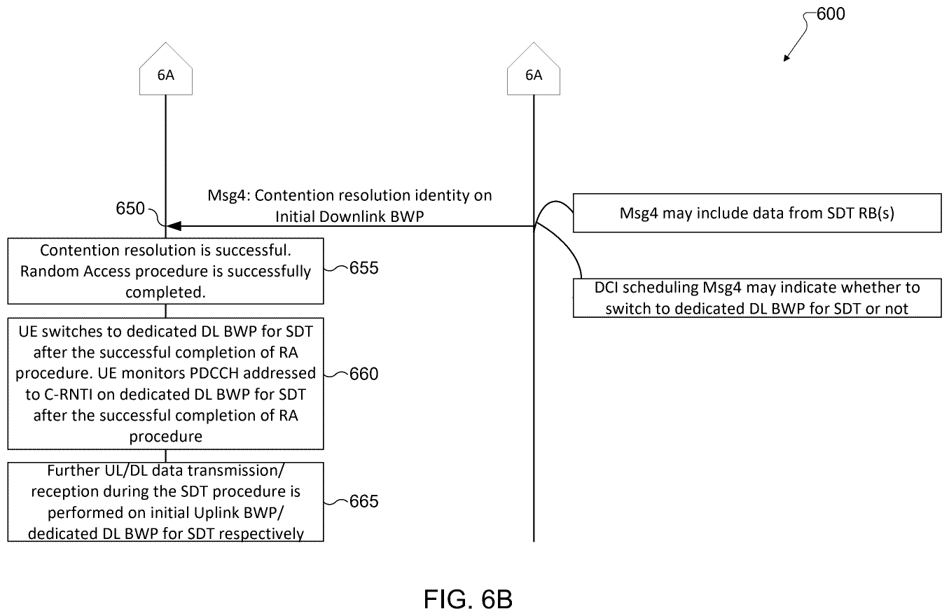

FIGS. 6A and 6B illustrate an example of a small data transmission procedure in a cell according to embodiments of the present disclosure. An embodiment of the procedure illustrated in FIGS. 6A and 6B is for illustration only. One or more of the components illustrated in FIGS. 6A and 6B may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIGS. 6A and 6B, a UE 602 may be in an RRC_INACTIVE or RRC_IDLE state in a camped cell. At operation 610, the UE 602 receives a configuration of an initial uplink BWP, a configuration of and initial downlink BWP and a configuration of a dedicated DL BWP for SDT from a gNB 604. The dedicated DL BWP for SDT may be for an MT-SDT procedure, an MO-SDT procedure or both. In some embodiments, the UE 602 may receive the configuration of the initial uplink BWP and configuration of the initial downlink BWP from system information of the camped cell. In some embodiments, the UE 602 may receive the configuration of the dedicated downlink BWP for SDT from system information of the camped cell or from a dedicated signaling message (e.g., an RRCRelease message received by UE 602 from the gNB 604). For example, the dedicated downlink BWP for a CG-SDT procedure can be received in a dedicated signaling message (e.g., an RRCRelease message from gNB 604), and the dedicated downlink BWP for an RA-SDT procedure can be received in system information of the camped cell.

At operation 625, UE 602 initiates an SDT procedure. In some embodiments, UE 602 may initiate the SDT procedure based on reception of paging message including an MT-SDT indication for the UE at operation 615. In some embodiments, UE 602 may initiate the SDT procedure based on arrival of uplink data from upper layers for one or more SDT radio bearer(s) at operation 620.

In some embodiments, the UE initiates a random access procedure upon initiation of SDT procedure. In some embodiments. the random access procedure may be explicitly triggered upon initiation of SDT procedure. Alternatively, in some embodiments, the random access procedure may be implicitly triggered based on initiation of transmission of an RRCResume Request/RRCResume request 1 message by the RRC layer in UE 602 (i.e., the RRC layer submits an RRCResume Request/RRCResume request 1 message in the buffer of a signaling radio bearer, this triggers BSR in the MAC layer which further triggers the random access procedure).

For the random access procedure, UE 602 selects the initial uplink BWP and initial downlink BWP where the size/bandwidth/RBs of the initial downlink BWP is the same as the size/bandwidth/RBs of CORESET 0.

In some embodiments, the UE 602 may perform a UE may perform 4 step random access procedure as follows:
At operation 630, the UE 602 transmits a random access preamble on the initial uplink BWP of the UL carrier (NUL or SUL). After transmitting the random access preamble, at operation 635 the UE 602 monitors for a PDCCH addressed to a RA-RNTI on the initial downlink BWP where the size/bandwidth/RBs of the initial downlink BWP is the same as the size/bandwidth/RBs of CORESET 0. At operation 640, the UE 602 receives a PDCCH addressed to an RA-RNTI scheduling a TB including a random access response. The UE 602 receives and decodes the scheduled TB including the random access response on the initial downlink BWP where the size/bandwidth/RBs of the initial downlink BWP is the same as the size/bandwidth/RBs of CORESET 0.
At operation 645, the UE 602 transmits a Msg3 including an RRCResume Request/RRCResume request 1 to gNB 604 on the initial uplink BWP based on an UL grant received in the random access response. The Msg3 may include data from one or more SDT RB(s). UE 602 may indicate in the Msg3 (or RRCResume Request/RRCResume request 1) that UE 602 supports dedicated DL BWP for SDT (or MT-SDT). In some embodiments, a new resume cause indicating MT-SDT using dedicated DL BWP for SDT may be included, or a 1 bit indication indicating MT-SDT (or SDT) using dedicated DL BWP may be included, or a 1 bit indication indicating that UE supports dedicated DL BWP for SDT (or MT-SDT) may be included, or a reserved LCID/ELCID to indicate that UE supports dedicated DL BWP for SDT (or MT-SDT) can be used in the MAC PDU for RRCResume Request/RRCResume request 1. Alternatively, in some embodiments, UE 602 may indicate to gNB 604 that UE 602 supports dedicated DL BWP for SDT (or MT-SDT) or UE 602 may indicate to gNB 604 in an RRC_CONNECTED state that UE 602 supports dedicated BWP for SDT (or MT-SDT) using an RRC message.
In some embodiments, UE 602 may indicate in Msg3 the (or RRCResume Request/RRCResume request 1) that UE 602 supports initial DL BWP without CORESET 0 restriction for SDT (or MT-SDT). In some embodiments, a new resume cause indicating MT-SDT using the initial DL BWP without CORESET 0 restriction for SDT may be included, or a 1 bit indication indicating MT-SDT (or SDT) using the initial DL BWP without CORESET 0 restriction may be included, or a 1 bit indication indicating that UE 602 supports initial DL BWP without CORESET 0 restriction for SDT (or MT-SDT) may be included, or a reserved LCID/ELCID to indicate that UE 602 supports initial DL BWP without CORESET 0 restriction for SDT (or MT-SDT) can be used in the MAC PDU for RRCResume Request/RRCResume request 1. Alternatively, in some embodiments, UE 602 may indicate to gNB 604 that UE 602 supports initial DL BWP without CORESET 0 restriction for SDT (or MT-SDT) or UE 602 may indicate to gNB 604 in an RRC_CONNECTED that UE 602 supports initial DL BWP without CORESET 0 restriction for SDT (or MT-SDT) using an RRC message.
UE 602 monitors for a PDCCH addressed to a TC-RNTI on the initial downlink BWP where the size/bandwidth/RBs of the initial downlink BWP is the same as the size/bandwidth/RBs of CORESET 0. TC-RNTI is received in a random access response. UE 602 receives a PDCCH addressed to a TC-RNTI scheduling Msg4. At operation 650, UE 602 receives and decodes the Msg4 on the initial downlink BWP where the size/bandwidth/RBs of the initial downlink BWP is the same as the size/bandwidth/RBs of CORESET 0. The Msg4 includes a contention resolution identity. The Msg4 may include data from SDT RB(s). UE 602 checks if the contention resolution identity corresponds to transmitted CCCH message (i.e., RRCResume Request/RRCResume request 1). If the contention resolution identity corresponds to transmitted CCCH message (i.e., RRCResume Request/RRCResume request 1), at operation 655 contention resolution is successful and the random access procedure is considered successfully completed.

In some embodiments, the UE 602 may perform a UE may perform a 2 step random access procedure as follows (not shown):
The UE 602 transmits a MsgA (random access preamble and MsgA MAC PDU) on the initial uplink BWP of the UL carrier (NUL or SUL). The MsgA includes an RRCResume Request/RRCResume request 1. MsgA may include data from one or more SDT RB(s). The UE 602 may indicate in the MsgA (or RRCResume Request/RRCResume request 1) that UE 602 supports dedicated DL BWP for SDT (or MT-SDT). In some embodiments, a new resume cause indicating MT-SDT using dedicated DL BWP for SDT may be included, or a 1 bit indication indicating MT-SDT (or SDT) using dedicated DL BWP may be included, or a 1 bit indication indicating that UE 602 supports dedicated DL BWP for SDT (or MT-SDT) may be included, or a reserved LCID/ELCID to indicate that UE 602 supports dedicated DL BWP for SDT (or MT-SDT) can be used in a MAC PDU for RRCResume Request/RRCResume request 1. Alternatively, in some embodiments, UE 602 may indicate to gNB 604 that UE 602 supports dedicated DL BWP for SDT (or MT-SDT) or UE 602 may indicate in an RRC_CONNECTED state that UE 604 supports dedicated BWP for SDT (or MT-SDT) using an RRC message.
In some embodiments, UE 602 may indicate in the MsgA (or RRCResume Request/RRCResume request 1) that UE 602 supports initial DL BWP without CORESET 0 restriction for SDT (or MT-SDT). In some embodiments, a new resume cause indicating MT-SDT using the initial DL BWP without CORESET 0 restriction for SDT may be included, or a 1 bit indication indicating MT-SDT (or SDT) using the initial DL BWP without CORESET 0 restriction may be included, or a 1 bit indication indicating that UE 602 supports initial DL BWP without CORESET 0 restriction for SDT (or MT-SDT) may be included, or a reserved LCID/ELCID to indicate that UE 602 supports initial DL BWP without CORESET 0 restriction for SDT (or MT-SDT) can be used in a MAC PDU for RRCResume Request/RRCResume request 1. Alternatively, in some embodiments, UE 602 may indicate to gNB 604 that UE 602 supports initial DL BWP without CORESET 0 restriction for SDT (or MT-SDT) or UE 602 may indicate to gNB 604 in an RRC_CONNECTED that UE 602 supports initial DL BWP without CORESET 0 restriction for SDT (or MT-SDT) using an RRC message.
After transmitting the MsgA, UE 602 monitors for a PDCCH addressed to a MSGB-RNTI on the initial downlink BWP where the size/bandwidth/RBs of the initial downlink BWP is the same as the size/bandwidth/RBs of CORESET 0. UE 602 receives a PDCCH addressed to a MsgB-RNTI scheduling a TB including a MsgB. UE 602 receives and decodes the scheduled TB including the MsgB on the initial downlink BWP where the size/bandwidth/RBs of the initial downlink BWP is the same as the size/bandwidth/RBs of CORESET 0.
The MsgB includes a contention resolution identity. The MsgB may include data from SDT RB(s). UE 602 checks if the contention resolution identity corresponds to a transmitted CCCH message (i.e., RRCResume Request/RRCResume request 1). If the contention resolution identity corresponds to the transmitted CCCH message (i.e., RRCResume Request/RRCResume request 1), contention resolution is successful and the random access procedure is considered successfully completed.

In some embodiments, at operation 660, UE 602 switches to a dedicated DL BWP for SDT after the successful completion of the RA procedure. UE 602 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on a dedicated DL BWP for SDT after the successful completion of the RA procedure. At operation 665, further UL/DL data transmission/reception during the SDT procedure is performed on the initial uplink BWP/dedicated DL BWP for SDT respectively. Since gNB 604 is aware of UE 602's capability (based on the UE capability indicated in the RRC_CONNECTED state or indication in the RRC Resume Request/RRC Resume Request 1 or LCID/eLCID used for RRC Resume Request/RRC Resume Request 1 in the initial UL transmission) that UE 602 supports dedicated BWP for SDT, gNB 604 can transmit to UE 602 in DL using the dedicated DL BWP.

Alternatively, in some embodiments, UE 602 switches to a dedicated DL BWP for SDT after the successful completion of the RA procedure, if the ongoing SDT procedure is triggered based on paging message and if the paging message indicates for UE 602 to switch to or use the dedicated DL BWP for SDT. UE 602 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on a dedicated DL BWP for SDT after switching. Further UL/DL data transmission/reception during the SDT procedure is performed on the initial Uplink BWP/dedicated DL BWP for SDT respectively.

Alternatively, in some embodiments, UE 602 switches to a dedicated DL BWP if indicated by the DCI of the PDCCH scheduling Msg4 (i.e., the PDCCH addressed to a TC-RNTI) or DCI of a PDCCH addressed to a C-RNTI, UE 602 then monitors for a PDCCH addressed to a C-RNTI on a dedicated DL BWP for SDT. Further UL/DL data transmission/reception during the SDT procedure is performed on the initial uplink BWP/dedicated DL BWP for SDT respectively. The network may switch the UE 602 back to the initial DL BWP by indicating the initial DL BWP in DCI of a PDCCH addressed to a C-RNTI during the SDT procedure.

In some embodiments, upon completion of random access procedure, during the SDT procedure UE 602's active DL BWP can be switched between the initial DL BWP and dedicated DL BWP for SDT by indication in DCI. The DCI indicates whether UE 602 switches to the initial DL BWP or the dedicated DL BWP.

In some embodiments, UE 601 switches to a dedicated UL BWP for SDT after the successful completion of the RA procedure during the SDT procedure. Alternatively, in some embodiments, UE 602 switches to a dedicated UL BWP if indicated by the DCI of a PDCCH addressed to a C-RNTI. In some embodiments, upon completion of the random access procedure, during the SDT procedure UE 602's active UL BWP can be switched between the initial UL BWP and the dedicated UL BWP for SDT by an indication in DCI.

In some embodiments, the initial downlink BWP and initial uplink BWP in the procedure of FIGS. 6A and 6B is a reduced capacity (redcap) specific initial downlink BWP and redcap specific initial uplink BWP.

In some embodiments, if the current active DL BWP during the SDT procedure is a dedicated DL BWP for SDT and random access is triggered during the SDT procedure (e.g., this random access procedure is triggered after the completion of the initial RA procedure for RA based SDT procedure or this random access procedure is triggered during the CG based ST procedure), UE 602 may switch to the initial DL BWP and initial UL BWP for the random access procedure. In some embodiments, if the current active DL BWP during the SDT procedure is the dedicated DL BWP for SDT and random access is triggered during the SDT procedure (e.g., this random access procedure is triggered after the completion of the initial RA procedure for RA based SDT procedure or this random access procedure is triggered during the CG based ST procedure), UE 602 may perform the random access procedure using the initial uplink BWP and dedicated DL BWP. In some embodiments, if the current active DL/UL BWP during the SDT procedure is a dedicated DL/UL BWP for SDT and the random access is triggered during the SDT procedure (e.g., this random access procedure is triggered after the completion of the initial RA procedure for RA based SDT procedure or this random access procedure is triggered during the CG based ST procedure), UE 602 may perform the random access procedure using the dedicated DL/UL BWP.

In some embodiments, UE 602 uses the initial downlink BWP (without CORESET 0 restriction) where the size/bandwidth/RBs of the initial downlink BWP is the same as the size/bandwidth/RBs indicated by the locationAndBandwidth field in the BWP configuration of the initial downlink BWP, after the successful completion of the RA procedure for SDT in the RRC_INACTIVE state. UE 602 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on the initial downlink BWP (without CORESET 0 restriction) where the size/bandwidth/RBs of the initial downlink BWP is the same as the size/bandwidth/RBs indicated by the locationAndBandwidth field in the BWP configuration of the initial downlink BWP, after the successful completion of the RA procedure. Further UL/DL data transmission/reception during the SDT procedure is performed on the initial Uplink BWP/initial DL BWP (without CORESET 0 restriction) where the size/bandwidth/RBs of the initial downlink BWP is the same as the size/bandwidth/RBs indicated by the locationAndBandwidth field in the BWP configuration of the initial downlink BWP respectively. Since gNB is aware of UE's capability (based on UE capability indicated in RRC_CONNECTED or indication in RRC Resume Request/RRC Resume Request 1 or LCID/eLCID used for RRC Resume Request/RRC Resume Request 1 in initial UL transmission) that it supports initial downlink BWP (or initial downlink BWP without coreset 0 restriction) where the size/bandwidth/RBs of the initial downlink BWP is the same as the size/bandwidth/RBs indicated by the locationAndBandwidth field in the BWP configuration of the initial downlink BWP, gNB 604 can transmit to UE 602 in DL using the initial DL BWP (without CORESET 0 restriction) where the size/bandwidth/RBs of the initial downlink BWP is the same as the size/bandwidth/RBs indicated by the locationAndBandwidth field in the BWP configuration of the initial downlink BWP.

Alternatively, in some embodiments, for SDT the UE 602 uses the initial downlink BWP (without CORESET 0 restriction) where the size/bandwidth/RBs of the initial downlink BWP is the same as the size/bandwidth/RBs indicated by the locationAndBandwidth field in the BWP configuration of the initial downlink BWP, after the successful completion of the RA procedure for SDT, if the ongoing SDT procedure is triggered based on a paging message and if the paging message indicates for UE 602 to use the initial downlink BWP (without CORESET 0 restriction) for SDT where the size/bandwidth/RBs of the initial downlink BWP is the same as the size/bandwidth/RBs indicated by the locationAndBandwidth field in the BWP configuration of the initial downlink BWP. UE 602 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on the initial downlink BWP (without CORESET 0 restriction) for SDT where the size/bandwidth/RBs of the initial downlink BWP is the same as the size/bandwidth/RBs indicated by the locationAndBandwidth field in the BWP configuration of the initial downlink BWP for SDT. Further UL/DL data transmission/reception during the SDT procedure is performed on the initial uplink BWP/initial downlink BWP (without CORESET 0 restriction) where the size/bandwidth/RBs of the initial downlink BWP is the same as the size/bandwidth/RBs indicated by the locationAndBandwidth field in the BWP configuration of the initial downlink BWP respectively.

Alternatively, in some embodiments, for SDT the UE 602 uses the initial downlink BWP (without CORESET 0 restriction) where the size/bandwidth/RBs of the initial downlink BWP is the same as the size/bandwidth/RBs indicated by the locationAndBandwidth field in the BWP configuration of the initial downlink BWP, if indicated by the DCI of a PDCCH scheduling Msg4 (i.e., a PDCCH addressed to a TC-RNTI) or DCI of a PDCCH addressed to a C-RNTI, UE 602 then monitors for a PDCCH addressed to a C-RNTI on the initial downlink BWP (without CORESET 0 restriction) where the size/bandwidth/RBs of the initial downlink BWP is the same as the size/bandwidth/RBs indicated by the locationAndBandwidth field in the BWP configuration of the initial downlink BWP, for SDT. Further UL/DL data transmission/reception during the SDT procedure is performed on the initial Uplink BWP/initial downlink BWP (without CORESET 0 restriction) where the size/bandwidth/RBs of the initial downlink BWP is the same as the size/bandwidth/RBs indicated by the locationAndBandwidth field in the BWP configuration of the initial downlink BWP, for SDT respectively. The network may switch the UE 602 back to initial DL BWP with CORESET 0 restriction by indicating in DCI of a PDCCH addressed to a C-RNTI during the SDT procedure.

Although FIGS. 6A and 6B illustrate one example of a small data transmission procedure in a cell 600, various changes may be made to FIGS. 6A and 6B. For example, while shown as a series of operations, various operations in FIGS. 6A and 6B could overlap, occur in parallel, occur in a different order, occur any number of times, be omitted, or replaced by other operations.

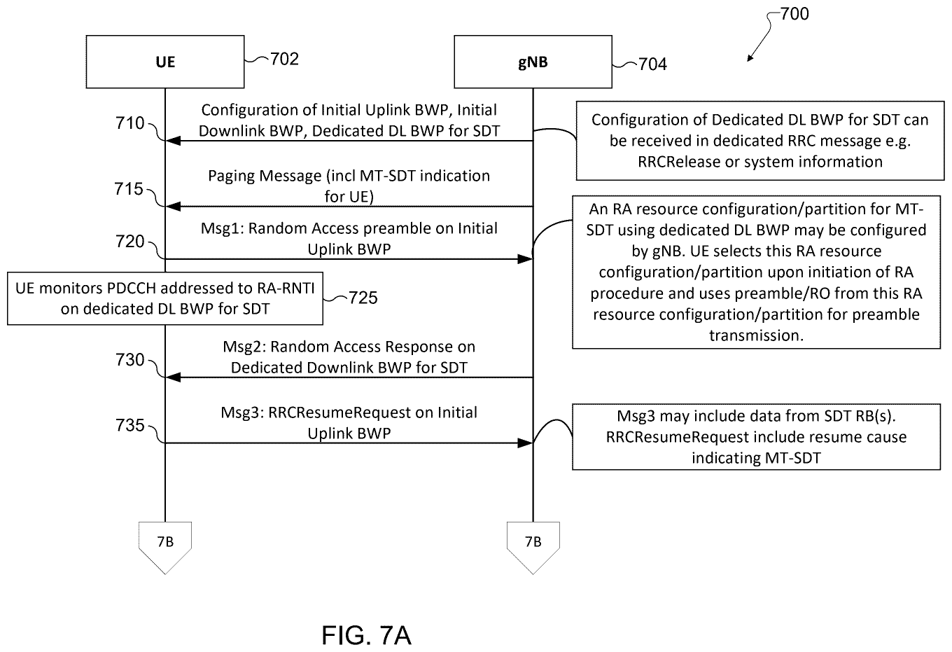

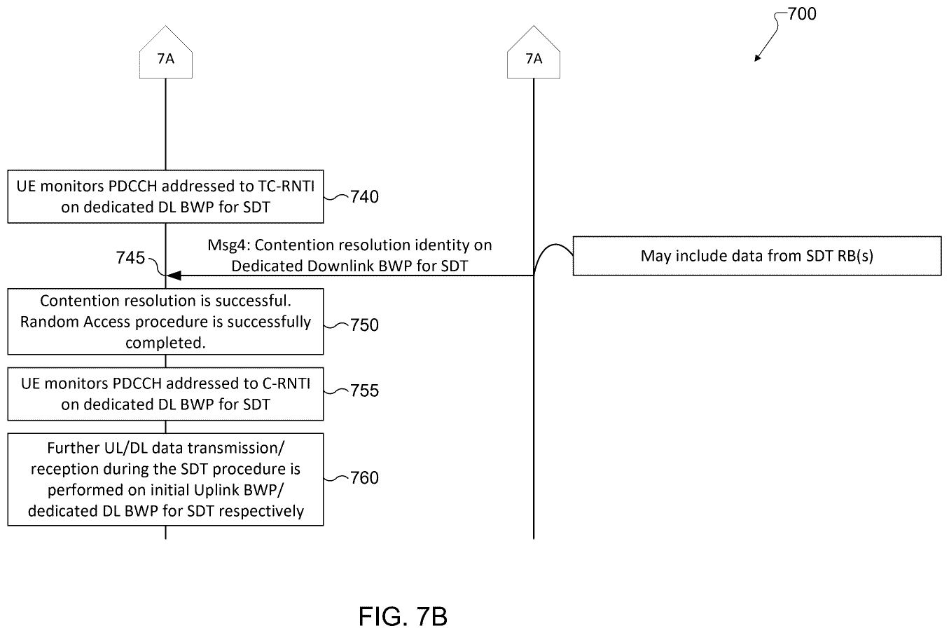

FIGS. 7A and 7B illustrate another example of a small data transmission procedure in a cell 700 according to embodiments of the present disclosure. An embodiment of the procedure illustrated in FIGS. 7A and 7B is for illustration only. One or more of the components illustrated in FIGS. 7A and 7B may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIGS. 7A and 7B, a UE 702 may be in an RRC_INACTIVE or RRC_IDLE state in a camped cell. At operation 710, the UE 702 receives configuration of the initial uplink BWP, configuration of the initial downlink BWP and configuration of a dedicated DL BWP for SDT from a gNB 704. The dedicated DL BWP for SDT may be for MT-SDT procedure, for MO-SDT procedure, or both. UE 702 may receive the configuration of the initial uplink BWP and the configuration of the initial downlink BWP from system information of the camped cell. UE 702 may receive the configuration of the dedicated downlink BWP for SDT from system information of the camped cell or from a dedicated signaling message (e.g., an RRCRelease message) received by UE 702 from the gNB 704. For example, the dedicated downlink BWP for CG-SDT procedure can be received in a dedicated signaling message (e.g., an RRCRelease message) from gNB 704, and the dedicated downlink BWP for RA-SDT procedure can be received in system information of the camped cell.

At operation 715, UE 702 initiates SDT procedure. UE 702 may initiate the SDT procedure based on reception of paging message including MT-SDT indication for the UE 702.

In some embodiments, UE 702 initiates a random access procedure upon initiation of the SDT procedure. In some embodiments the random access procedure may be explicitly triggered upon initiation of the SDT procedure. Alternatively, in some embodiments the random access procedure may be implicitly triggered based on initiation of transmission of an RRCResume Request/RRCResume request 1 message by the RRC layer in UE 702 (e.g., the RRC layer submits an RRCResume Request/RRCResume request 1 message in the buffer of a signaling radio bearer, this triggers BSR in the MAC layer which further triggers the random access procedure).

For the random access procedure, UE 702 selects the initial uplink BWP and dedicated downlink BWP for SDT.

An RA resource configuration/partition for MT-SDT using the dedicated DL BWP may be configured by gNB 704. UE 702 selects this RA resource configuration/partition upon initiation of the RA procedure and uses a preamble/RO from this RA resource configuration/partition for the random access procedure. This enables gNB 704 to identify that UE 702 supports dedicated BWP for SDT.

In some embodiments, the UE 702 may perform a 4 step random access procedure as follows:
At operation 720, UE 702 transmits a random access preamble on the initial uplink BWP of the UL carrier (NUL or SUL).
After transmitting the random access preamble (or after transmitting the random access preamble and if the paging message indicates for UE 702 to use the dedicated DL BWP for SDT), at operation 725 UE 702 monitors for a PDCCH addressed to a RA-RNTI on the dedicated downlink BWP for SDT. At operation 730, UE 702 receives a PDCCH addressed to a RA-RNTI scheduling TB including random access response. UE 702 receives and decodes the TB including random access response on the dedicated downlink BWP for SDT.

At operation 735, UE 702 transmits a Msg3 including RRCResume Request/RRCResume request 1 to gNB 704 on the initial uplink BWP based on the UL grant received in the random access response. The Msg3 may include data from one or more SDT RB(s). The RRCResume Request/RRCResume request 1 includes a resume cause indicating MT-SDT.

At operation 740, UE 702 monitors for a PDCCH addressed to a TC-RNTI on the dedicated downlink BWP for SDT. The TC-RNTI is received in random access response. UE 702 receives a PDCCH addressed to a TC-RNTI scheduling Msg4. At operation 745, UE 702 receives and decodes the Msg4 on the dedicated downlink BWP for SDT. The Msg4 includes a contention resolution identity. The Msg4 may include data from SDT RB(s). UE 702 checks if the contention resolution identity corresponds to transmitted CCCH message (i.e., RRCResume request). At operation 750, If the contention resolution identity corresponds to transmitted CCCH message (i.e., RRCResume Request/RRCResume request 1), contention resolution is successful and the random access procedure is considered successfully completed.

In some embodiments, the UE 702 may perform a 2 step random access procedure as follows (not shown):
UE 702 transmits a MsgA (random access preamble and MsgA MAC PDU) on the initial uplink BWP of the UL carrier (NUL or SUL). The MsgA includes an RRC Resume request. The MsgA may include data from one or more SDT RB(s). The RRCResumeRequest includes a resume cause indicating MT-SDT.
After transmitting the MsgA (or after transmitting the MsgA and if a paging message indicates for UE 702 to use the dedicated DL BWP for SDT), UE 702 monitors for a PDCCH addressed to a MSGB-RNTI on the dedicated downlink BWP for SDT. UE 702 receives a PDCCH addressed to a MsgB-RNTI scheduling a TB including a MsgB. UE 702 receives and decodes the TB including MsgB on the dedicated downlink BWP for SDT.
The MsgB includes a contention resolution identity. The MsgB may include data from SDT RB(s). UE 702 checks if the contention resolution identity corresponds to a transmitted CCCH message (i.e., RRCResume Request/RRCResume request 1). If the contention resolution identity corresponds to the transmitted CCCH message (i.e., RRCResume Request/RRCResume request 1), the contention resolution is successful and the random access procedure is considered successfully completed.

At operation 755, UE 702 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on the dedicated DL BWP for SDT after the successful completion of the RA procedure. At operation 760, further UL/DL data transmission/reception during the SDT procedure is performed on the initial uplink BWP/dedicated DL BWP for SDT respectively.

In some embodiments, upon completion of the random access procedure, during the SDT procedure, UE 702's active DL BWP can be switched between the initial DL BWP and dedicated DL BWP for SDT by indication in DCI. The DCI indicates whether UE 702 switches to the initial DL BWP or dedicated DL BWP. In some embodiments, upon completion of the random access procedure, during the SDT procedure UE 702's active UL BWP can be switched between the initial UL BWP and dedicated UL BWP for SDT by indication in DCI.

In some embodiments, the initial downlink BWP and initial uplink BWP in the procedure of FIGS. 7A and 7B is a redcap specific initial downlink BWP and redcap specific initial uplink BWP.

In some embodiments, in the procedure of FIGS. 7A and 7B, the initial downlink BWP refers to the initial downlink BWP with CORESET 0 restriction (i.e., the size/bandwidth/RBs of the initial downlink BWP is the same as the size/bandwidth/RBs of CORESET 0) and the dedicated downlink BWP refers to the initial downlink BWP without CORESET 0 restriction (i.e., the size/bandwidth/RBs of the initial downlink BWP is the same as size/bandwidth/RBs indicated by the locationAndBandwidth field in the BWP configuration of the initial downlink BWP).

Although FIGS. 7A and 7B illustrate one example of a small data transmission procedure in a cell 700, various changes may be made to FIGS. 7A and 7B. For example, while shown as a series of operations, various operations in FIGS. 7A and 7B could overlap, occur in parallel, occur in a different order, occur any number of times, be omitted, or replaced by other operations.

FIGS. 8A and 8B illustrate another example of a small data transmission procedure in a cell 800 according to embodiments of the present disclosure. An embodiment of the procedure illustrated in FIGS. 8A and 8B is for illustration only. One or more of the components illustrated in FIGS. 8A and 8B may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIGS. 8A and 8B, a UE 802 may be in an RRC_INACTIVE or RRC_IDLE state in a camped cell. At operation 810, the UE 802 receives a configuration of the initial uplink BWP, a configuration of the initial downlink BWP, a configuration of a dedicated UL BWP for SDT and a configuration of a dedicated DL BWP for SDT from a gNB 804. The dedicated DL BWP for SDT and dedicated UL BWP for SDT may be for MT-SDT procedure, for MO-SDT procedure, or both. UE 802 may receive the configuration of the initial uplink BWP and the configuration of the initial downlink BWP from system information of the camped cell. UE 802 may receive the configuration of the dedicated downlink BWP for SDT and dedicated UL BWP for SDT from system information of the camped cell or from a dedicated signaling message (e.g., an RRCRelease message) received by UE 802 from the gNB 804. For example, the dedicated downlink BWP and dedicated UL BWP for a CG-SDT procedure can be received in a dedicated signaling message (e.g., an RRCRelease message) from gNB 804, and the dedicated downlink BWP and dedicated UL BWP for a RA-SDT procedure can be received in system information of the camped cell.

At operation 825, the UE 802 initiates an SDT procedure. In some embodiments, UE 802 may initiate the SDT procedure based on reception of a paging message including MT-SDT indication for the UE at operation 815. In some embodiments, the UE may initiate the SDT procedure based on arrival of uplink data from upper layers for one or more SDT radio bearer(s) at operation 820.

In some embodiments, UE 802 initiates a random access procedure upon initiation of the SDT procedure. In some embodiments the random access procedure may be explicitly triggered upon initiation of SDT procedure. Alternatively, in some embodiments the random access procedure may be implicitly triggered based on initiation of transmission of an RRCResume Request/RRCResume request 1 message by the RRC layer in UE 802 (for example, the RRC layer may submits an RRCResume Request/RRCResume request 1 message in the buffer of a signaling radio bearer, this triggers BSR in the MAC layer which further triggers the random access procedure).

UE 802 selects the dedicated UL BWP for SDT and dedicated DL BWP for SDT. In some embodiments, if the SDT procedure is initiated based on a paging message and the paging message indicate for UE 802 to use the dedicated UL BWP for SDT and dedicated DL BWP for SDT, UE 802 selects the dedicated UL BWP for SDT and dedicated DL BWP for SDT. If the dedicated UL BWP for SDT is not configured, the initial uplink BWP is used in the procedure of FIGS. 8A and 8B in place of a dedicated UL BWP for SDT. If a dedicated DL BWP for SDT is not configured, the initial downlink BWP is used in below operation in place of a dedicated DL BWP for SDT.

In some embodiments, UE 802 may perform a 4 step random access procedure as follows:
At operation 830, UE 802 transmits a random access preamble on the dedicated UL BWP for SDT of UL carrier (NUL or SUL).
After transmitting the random access preamble, at operation 835 UE 802 monitors for a PDCCH addressed to a RA-RNTI on the dedicated downlink BWP for SDT. At operation 840, UE 702 receives a PDCCH addressed to a RA-RNTI scheduling TB including a random access response on the dedicated downlink BWP for SDT. UE 702 receives and decodes the TB including the random access response on the dedicated downlink BWP for SDT.
At operation 845, UE 802 transmits a Msg3 including an RRCResume Request/RRCResume request 1 to gNB 804 on the dedicated UL BWP for SDT based on the UL grant received in the random access response. The Msg3 may include data from one or more SDT RB(s). The RRCResume Request/RRCResume request 1 includes a resume cause indicating MT-SDT if SDT procedure is initiated based on the paging message.
At operation 850, UE 802 monitors for a PDCCH addressed to a TC-RNTI on the dedicated downlink BWP for SDT. The TC-RNTI is received in a random access response. At operation 855, UE 802 receives a PDCCH addressed to a TC-RNTI scheduling Msg4. UE 702 receives and decodes the Msg4 on the dedicated downlink BWP for SDT. The Msg4 includes contention resolution identity. The Msg4 may include data from SDT RB(s). UE 802 checks if the contention resolution identity corresponds to transmitted CCCH message i.e., RRCResume request. At operation 860, if the contention resolution identity corresponds to the transmitted CCCH message (i.e., RRCResume Request/RRCResume request 1), the contention resolution is successful and the random access procedure is considered successfully completed.

In some embodiments, UE 802 may perform 2 step random access procedure as follows (not shown):
UE 802 transmits a MsgA (a random access preamble and MsgA MAC PDU) on the dedicated UL BWP for SDT of the UL carrier (NUL or SUL). The MsgA includes an RRC resume request. The MsgA may include data from one or more SDT RB(s). The RRCResumeRequest includes a resume cause indicating MT-SDT if the SDT procedure is initiated based on a paging message.
After transmitting the MsgA, UE 802 monitors for a PDCCH addressed to a MSGB-RNTI on the dedicated downlink BWP for SDT. UE 802 receives a PDCCH addressed to a MsgB-RNTI scheduling a TB including a MsgB. UE 802 receives and decodes the TB including the MsgB on the dedicated downlink BWP for SDT.
The MsgB includes a contention resolution identity. The MsgB may include data from SDT RB(s). UE 802 checks if the contention resolution identity corresponds to the transmitted CCCH message (i.e., RRCResume Request/RRCResume request 1). If the contention resolution identity corresponds to the transmitted CCCH message (i.e., RRCResume Request/RRCResume request 1), the contention resolution is successful and the random access procedure is considered successfully completed.

The Preamble or MsgA transmission in the dedicated UL BWP for SDT enables gNB to identify that UE 802 supports dedicated DL/UL BWP for SDT.

At operation 865, UE 802 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on the dedicated DL BWP for SDT after the successful completion of the RA procedure. At operation 870. further UL/DL data transmission/reception during the SDT procedure is performed on the dedicated UL BWP for SDT/redicated DL BWP for SDT respectively.

In some embodiments, upon completion of the random access procedure, during the SDT procedure UE 802's active DL BWP can be switched between the initial DL BWP and dedicated DL BWP for SDT by indication in DCI. The DCI indicates whether UE switches to the initial DL BWP or dedicated DL BWP. In some embodiments, upon completion of the random access procedure, during the SDT procedure UE 802's active UL BWP can be switched between the initial UL BWP and dedicated UL BWP for SDT by indication in DCI.

In some embodiments, the initial downlink BWP and initial uplink BWP in the procedure of FIGS. 8A and 8B are a redcap specific initial downlink BWP and a redcap specific initial uplink BWP.

In some embodiments, in the procedure of FIGS. 8A and 8B, the initial downlink BWP refers to the initial downlink BWP with CORESET 0 restriction (i.e., size/bandwidth/RBs of the initial downlink BWP is the same as size/bandwidth/RBs of CORESET 0) and the dedicated downlink BWP refers to the initial downlink BWP without CORESET 0 restriction (i.e., the size/bandwidth/RBs of the initial downlink BWP is the same as the size/bandwidth/RBs indicated by the locationAndBandwidth field in the BWP configuration of the initial downlink BWP).

Although FIGS. 8A and 8B illustrate one example of a small data transmission procedure in a cell 800, various changes may be made to FIGS. 8A and 8B. For example, while shown as a series of operations, various operations in FIGS. 8A and 8B could overlap, occur in parallel, occur in a different order, occur any number of times, be omitted, or replaced by other operations.

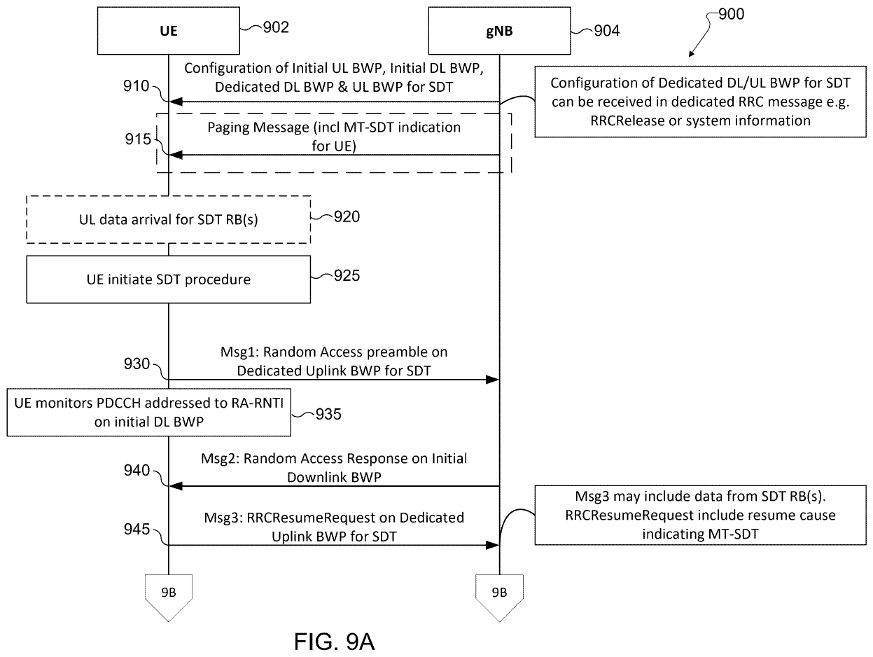

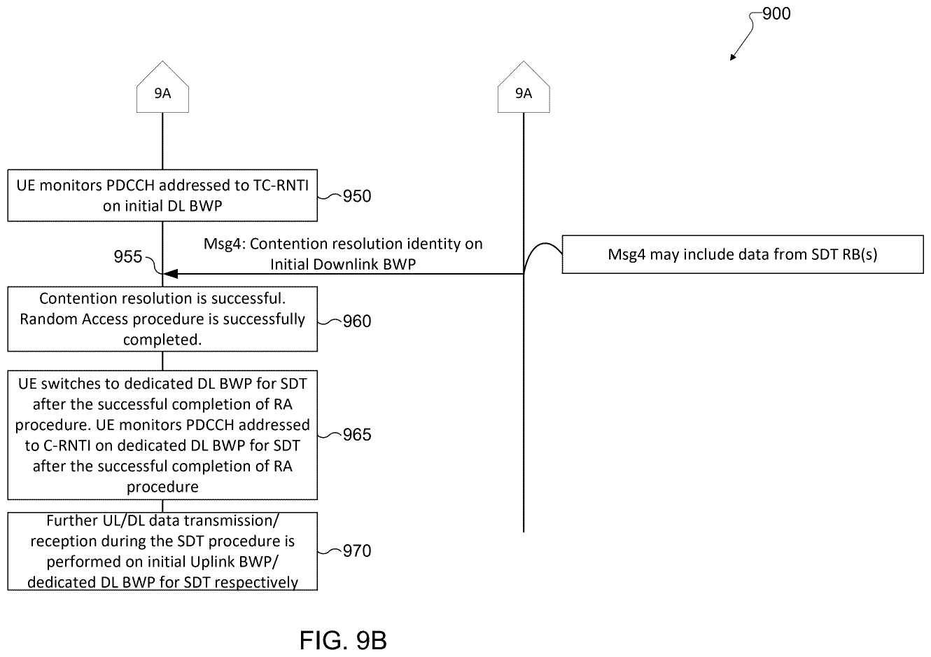

FIGS. 9A and 9B illustrate another example of a small data transmission procedure in a cell 900 according to embodiments of the present disclosure. An embodiment of the procedure illustrated in FIGS. 9A and 9B is for illustration only. One or more of the components illustrated in FIGS. 9A and 9B may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIGS. 9A and 9B, a UE 902 may be in an RRC_INACTIVE or RRC_IDLE state in a camped cell. At operation 910, the UE 902 receives a configuration of the initial uplink BWP, a configuration of the initial downlink BWP, a configuration of a dedicated UL BWP for SDT and a configuration of a dedicated DL BWP for SDT from a gNB 904. The dedicated DL BWP for SDT and dedicated UL BWP for SDT may be for MT-SDT procedure, for MO-SDT procedure, or both. UE 902 may receive the configuration of the initial uplink BWP and the configuration of the initial downlink BWP from system information of the camped cell. UE 902 may receive the configuration of the dedicated downlink BWP for SDT and the dedicated UL BWP for SDT from system information of the camped cell or from a dedicated signaling message (e.g., RRCRelease message) received by UE 902 from the gNB 904. For example, the dedicated downlink BWP and dedicated UL BWP for a CG-SDT procedure can be received in a dedicated signaling message (e.g., RRCRelease message) from gNB 904, and the dedicated downlink BWP and dedicated UL BWP for an RA-SDT procedure can be received in system information of the camped cell.

At operation 925, UE 902 initiates an SDT procedure. In some embodiments, UE 902 may initiate the SDT procedure based on reception of paging message including MT-SDT indication for the UE 902 at operation 915. In some embodiments, UE 902 may initiate the SDT procedure based on the arrival of uplink data from upper layers for one or more SDT radio bearer(s).

In some embodiments, UE 902 initiates a random access procedure upon initiation of the SDT procedure. In some embodiments the random access procedure may be explicitly triggered upon initiation of the SDT procedure. Alternatively, in some embodiments the random access procedure may be implicitly triggered based on initiation of transmission of an RRCResume Request/RRCResume request 1 message by the RRC layer in UE 902 (e.g., the RRC layer submits and RRCResume Request/RRCResume request 1 message in the buffer of a signaling radio bearer, this triggers BSR in the MAC layer which further triggers random access procedure).

For the RA procedure (e.g., for the first RA procedure upon initiation of RA based SDT procedure), UE 902 selects the dedicated UL BWP for SDT and initial DL BWP.

In some embodiments, UE 902 may perform a 4 step random access procedure as follows:
At operation 930, UE 902 a transmits random access preamble on the dedicated UL BWP for SDT of the UL carrier (NUL or SUL).
After transmitting the random access preamble, at operation 935 UE 902 monitors for a PDCCH addressed to a RA-RNTI on the initial DL BWP. At operation 940, UE 902 receives a PDCCH addressed to a RA-RNTI scheduling TB including a random access response on the initial DL BWP. UE 902 receives and decodes the TB including the random access response initial DL BWP.
At operation 945, UE 902 transmits a Msg3 including an RRCResume Request/RRCResume request 1 to gNB 904 on the dedicated UL BWP for SDT based on the UL grant received in the random access response. The Msg3 may include data from one or more SDT RB(s). The RRCResume Request/RRCResume request 1 includes a resume cause indicating MT-SDT if the SDT procedure is initiated based on a paging message.
At operation 950, UE 902 monitors for a PDCCH addressed to a TC-RNTI on the initial DL BWP. The TC-RNTI is received in the random access response. UE 902 receives a PDCCH addressed to a TC-RNTI scheduling Msg4. At operation 955, UE 902 receives and decodes the Msg4 on the initial DL BWP for SDT. The Msg4 includes a contention resolution identity. The Msg4 may include data from SDT RB(s). UE 902 checks if the contention resolution identity corresponds to a transmitted CCCH message (i.e., RRCResume request). At operation 960, if the contention resolution identity corresponds to the transmitted CCCH message (i.e., RRCResume Request/RRCResume request 1), contention resolution is successful and the random access procedure is considered successfully completed.

In some embodiments, UE 902 may perform a 2 step random access procedure as follows (not shown):
UE 902 transmits a MsgA (random access preamble and MsgA MAC PDU) on the dedicated UL BWP for SDT of the UL carrier (NUL or SUL). The MsgA includes an RRC Resume request. The MsgA may include data from one or more SDT RB(s). The RRCResumeRequest includes a resume cause indicating MT-SDT if SDT procedure is initiated based on a paging message.
After transmitting the MsgA, UE 902 monitors for a PDCCH addressed to a MSGB-RNTI on the initial DL BWP. UE receives a PDCCH addressed to a MsgB-RNTI scheduling a TB including a MsgB. UE 902 receives and decodes the TB including the MsgB on the initial DL BWP.
The MsgB includes a contention resolution identity. The MsgB may include data from SDT RB(s). UE 902 checks if the contention resolution identity corresponds to a transmitted CCCH message (i.e., RRCResume Request/RRCResume request 1). If the contention resolution identity corresponds to the transmitted CCCH message (i.e., RRCResume Request/RRCResume request 1), contention resolution is successful and the random access procedure is considered successfully completed.

In some embodiments, at operation 965, UE 902 switches to the dedicated DL BWP for SDT after the successful completion of the RA procedure. UE 902 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on the dedicated DL BWP for SDT after the successful completion of the RA procedure. At operation 970, further UL/DL data transmission/reception during the SDT procedure is performed on the dedicated UL BWP for SDT/dedicated DL BWP for SDT respectively.

Alternatively, in some embodiments, UE switches to dedicated DL BWP for SDT after the successful completion of the RA procedure, if the ongoing SDT procedure is triggered based on a paging message and if the paging message indicates for UE 902 to switch to or use the dedicated DL BWP for SDT. UE 902 monitors for a PDCCH addressed to a C-RNTI (in the case of a 4 step RA procedure, the TC-RNTI in the random access response is promoted to a C-RNTI after contention resolution is successful; in the case of a 2 step RA procedure, the C-RNTI is received in the MsgB) on the dedicated DL BWP for SDT after switching. Further UL/DL data transmission/reception during the SDT procedure is performed on the dedicated UL BWP for SDT/dedicated DL BWP for SDT respectively.

Alternatively, in some embodiments, UE 902 switches to the dedicated DL BWP if indicated by the DCI of a PDCCH scheduling Msg4 (i.e., a PDCCH addressed to a TC-RNTI) or DCI of PDCCH addressed to a C-RNTI, UE 902 then monitors for a PDCCH addressed to a C-RNTI on the dedicated DL BWP for SDT. Further UL/DL data transmission/reception during the SDT procedure is performed on the dedicated UL BWP for SDT/dedicated DL BWP for SDT respectively. The network may switch the UE back to the initial DL BWP by indicating the initial DL BWP in DCI of a PDCCH addressed to a C-RNTI during the SDT procedure.

In some embodiments, upon completion of the random access procedure, during the SDT procedure UE 902's active DL BWP can be switched between the initial DL BWP and dedicated DL BWP for SDT by indication in DCI. The DCI indicates whether UE 902 switches to the initial DL BWP or dedicated DL BWP.

In some embodiments, upon completion of the random access procedure, during the SDT procedure UE 902's active UL BWP can be switched between the initial UL BWP and dedicated UL BWP for SDT by indication in DCI.

In some embodiments, the initial downlink BWP and initial uplink BWP in the procedure of FIGS. 9A and 9B are a redcap specific initial downlink BWP and redcap specific initial uplink BWP.

In some embodiments, if the current active DL BWP during the SDT procedure is a dedicated DL BWP for SDT and the random access is triggered during the SDT procedure (e.g., this random access procedure is triggered after the completion of the initial RA procedure for an RA based SDT procedure or this random access procedure is triggered during a CG based ST procedure), UE 902 may switch to the initial DL BWP and initial UL BWP for the random access procedure. In some embodiments, if the current active DL BWP during the SDT procedure is a dedicated DL BWP for SDT and the random access is triggered during the SDT procedure (e.g., this random access procedure is triggered after the completion of the initial RA procedure for RA based SDT procedure or this random access procedure is triggered during the CG based ST procedure), UE 902 may perform the random access procedure using the initial uplink BWP and dedicated DL BWP. In some embodiments, if the current active DL/UL BWP during the SDT procedure is a dedicated DL/UL BWP for SDT and the random access is triggered during the SDT procedure (e.g., this random access procedure is triggered after the completion of the initial RA procedure for RA based SDT procedure or this random access procedure is triggered during the CG based ST procedure), UE 902 may perform the random access procedure using the dedicated DL/UL BWP.

In some embodiments, in the procedure of FIGS. 9A and 9B, the initial downlink BWP refers to the initial downlink BWP with CORESET 0 restriction (i.e., the size/bandwidth/RBs of the initial downlink BWP is the same as the size/bandwidth/RBs of CORESET 0) and the dedicated downlink BWP refers to the initial downlink BWP without CORESET 0 restriction (i.e., the size/bandwidth/RBs of the initial downlink BWP is the same as size/bandwidth/RBs indicated by the locationAndBandwidth field in the BWP configuration of the initial downlink BWP).

Although FIGS. 9A and 9B illustrate one example of a small data transmission procedure in a cell 900, various changes may be made to FIGS. 9A and 9B. For example, while shown as a series of operations, various operations in FIGS. 9A and 9B could overlap, occur in parallel, occur in a different order, occur any number of times, be omitted, or replaced by other operations.

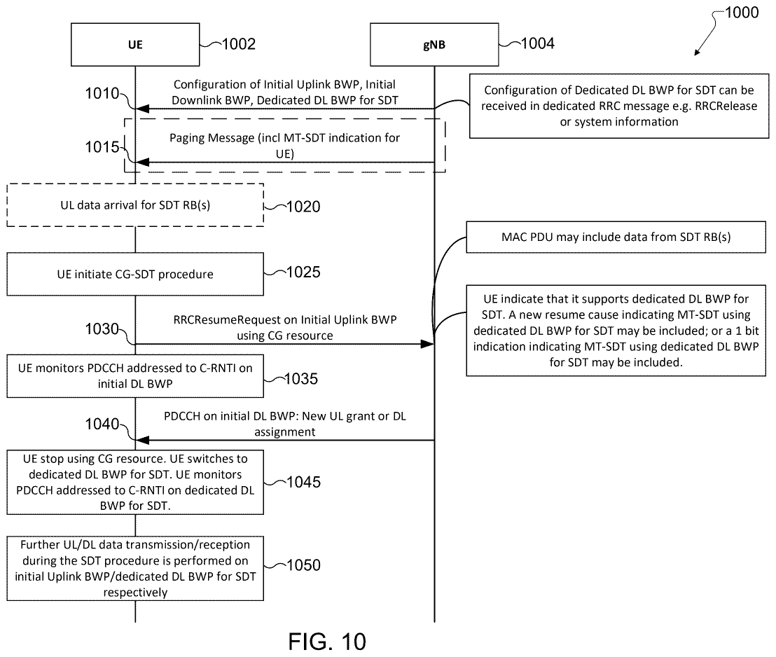

FIG. 10 illustrates another example of a small data transmission procedure in a cell 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIG. 10, a UE 1002 may be in an RRC_INACTIVE or RRC_IDLE state in a camped cell. At operation 1010, the UE 1002 receives a configuration of the initial uplink BWP, a configuration of the initial downlink BWP and a configuration of a dedicated DL BWP for SDT from gNB 1004. The dedicated DL BWP for SDT may be for MT-SDT procedure, for MO-SDT procedure, or both. UE 1002 may receive the configuration of the initial uplink BWP and configuration of the initial downlink BWP from system information of the camped cell. UE 1002 may receive the configuration of the dedicated downlink BWP for SDT from system information of the camped cell or from a dedicated signaling message (e.g., an RRCRelease message) received by UE 1002 from the gNB 1004. For example, the dedicated downlink BWP for a CG-SDT procedure can be received in a dedicated signaling message (e.g., and RRCRelease) message from gNB 1004, and the dedicated downlink BWP for an RA-SDT procedure can be received in system information of the camped cell.

At operation 1025, UE 1002 initiates a CG based SDT procedure. In some embodiments, the UE 1002 may initiate the SDT procedure based on reception of paging message including MT-SDT indication for the UE at operation 1015. In some embodiments, the UE 1002 may initiate the SDT procedure based on arrival of uplink data from upper layers for one or more SDT radio bearer(s) at operation 1020.

At operation 1030, UE 1002 transmits an RRC Resume Request/RRC Resume Request 1 to gNB 1004 on the initial uplink BWP using a CG resource. This transmission may also be referred to as an initial uplink transmission or initial uplink transmission including CCCH message/SDU. A MAC PDU transmitted in the CG resource may include data from one or more SDT RB(s) in addition to the RRC Resume Request/RRC Resume Request 1. In some embodiments, UE 1002 may indicate in the MAC PDU (or RRCResume Request/RRCResume request 1) that UE 1002 supports dedicated DL BWP for SDT (or MT-SDT). A new resume cause indicating MT-SDT using dedicated DL BWP for SDT may be included, or a 1 bit indication indicating MT-SDT (or SDT) using dedicated DL BWP may be included, or a 1 bit indication indicating that UE supports dedicated DL BWP for SDT (or MT-SDT) may be included, or a reserved LCID/ELCID to indicate that UE 1002 supports dedicated DL BWP for SDT (or MT-SDT) can be used in the MAC PDU for RRCResume Request/RRCResume request 1.

In some embodiments, UE 1002 may indicate in the MAC PDU (or RRCResume Request/RRCResume request 1) that UE 1002 supports initial DL BWP without CORESET 0 restriction for SDT (or MT-SDT). A new resume cause indicating MT-SDT using the initial DL BWP without CORESET 0 restriction for SDT may be included, or a 1 bit indication indicating MT-SDT (or SDT) using the initial DL BWP without CORESET 0 restriction may be included, or a 1 bit indication indicating that UE supports initial DL BWP without CORESET 0 restriction for SDT (or MT-SDT) may be included, or a reserved LCID/ELCID to indicate that UE supports initial DL BWP without CORESET 0 restriction for SDT (or MT-SDT) can be used in the MAC PDU for RRCResume Request/RRCResume request 1.

Alternatively, in some embodiments, UE 1002 may indicate to gNB 1004 that UE 1002 supports dedicated DL BWP for SDT (or MT-SDT) or UE 1002 may indicate in an RRC_CONNECTED state that UE 1002 supports dedicated BWP for SDT (or MT-SDT) using an RRC message. Alternatively, in some embodiments, UE 1002 may indicate to gNB 1004 that UE 1002 supports initial DL BWP without CORESET 0 restriction for SDT (or MT-SDT) or UE 1002 may indicate in an RRC_CONNECTED state that UE 1002 supports initial DL BWP without CORESET 0 restriction for SDT (or MT-SDT) using an RRC message.

At operation 1030, UE 1002 monitors for a PDCCH addressed to a C-RNTI on the initial downlink BWP to receive a response from gNB 1004 for the initial uplink transmission including the RRC Resume Request/RRC Resume Request 1. At operation 1040, UE 1002 receives the PDCCH scheduling a new UL grant or new DL assignment on the initial downlink BWP.

In some embodiments, upon reception of the PDCCH scheduling a new UL grant or new DL assignment (this reception may also be referred to as an ACK for initial UL transmission), at operation 1045 UE 1002 stops using the CG resource, and UE 1002 switches to dedicated DL BWP for SDT and UE monitors for a PDCCH addressed to a C-RNTI on the dedicated DL BWP for SDT. At operation 1050, further UL/DL data transmission/reception to/from gNB during the SDT procedure is performed on the initial uplink BWP/dedicated DL BWP for SDT respectively. Since gNB 1004 is aware of UE 1002's capability (based on the UE capability indicated in RRC_CONNECTED or indication in the RRC Resume Request/RRC Resume Request 1 or LCID/eLCID used for RRC Resume Request/RRC Resume Request 1 in initial UL transmission) that UE 1002 supports dedicated BWP for SDT, gNB 1004 can transmit to UE 1002 in DL using the dedicated DL BWP.

Alternatively, in some embodiments, upon reception of the PDCCH scheduling a new UL grant or new DL assignment, UE 1002 switches to the dedicated DL BWP for SDT and the UE monitors for a PDCCH addressed to a C-RNTI on the dedicated DL BWP for SDT if the ongoing SDT procedure is triggered based on a paging message and if the paging message indicates for UE 1002 to switch to or use the dedicated DL BWP for SDT.

Alternatively, in some embodiments, upon reception of the PDCCH scheduling a new UL grant or new DL assignment, UE 1002 switches to the dedicated DL BWP for SDT and UE 1002 monitors for a PDCCH addressed to a C-RNTI on the dedicated DL BWP for SDT if the DCI of the received PDCCH scheduling a new UL grant or new DL assignment indicate for UE 1002 to switch to the dedicated DL BWP. Further UL/DL data transmission/reception during the SDT procedure is performed on the initial uplink BWP/dedicated DL BWP for SDT respectively. The network may switch the UE 1002 back to the initial DL BWP by indicating the initial DL BWP in DCI of a PDCCH addressed to a C-RNTI during the SDT procedure.

Alternatively, in some embodiments, upon reception of the PDCCH scheduling a new UL grant or new DL assignment, UE 1002 switches to the dedicated UL BWP for SDT. Alternatively, in some embodiments, during the SDT procedure, UE 1002 switches to the dedicated UL BWP if indicated by the DCI of PDCCH addressed to a C-RNTI. In some embodiments, upon reception of the PDCCH scheduling a new UL grant or new DL assignment, during the SDT procedure UE 1002's active UL BWP can be switched between the initial UL BWP and the dedicated UL BWP for SDT by indication in DCI.

In some embodiments, the initial downlink BWP and initial uplink BWP in the procedure of FIG. 10 are a redcap specific initial downlink BWP and a redcap specific initial uplink BWP.

In some embodiments, in the procedure of FIG. 10, the initial downlink BWP refers to the initial downlink BWP with CORESET 0 restriction (i.e., size/bandwidth/RBs of the initial downlink BWP is the same as size/bandwidth/RBs of CORESET 0) and the dedicated downlink BWP refers to the initial downlink BWP without CORESET 0 restriction (i.e., size/bandwidth/RBs of the initial downlink BWP is the same as size/bandwidth/RBs indicated by the locationAndBandwidth field in the BWP configuration of the initial downlink BWP).

Although FIG. 10 illustrates one example of a small data transmission procedure in a cell 1000, various changes may be made to FIG. 10. For example, while shown as a series of operations, various operations in FIG. 10 could overlap, occur in parallel, occur in a different order, occur any number of times, be omitted, or replaced by other operations.

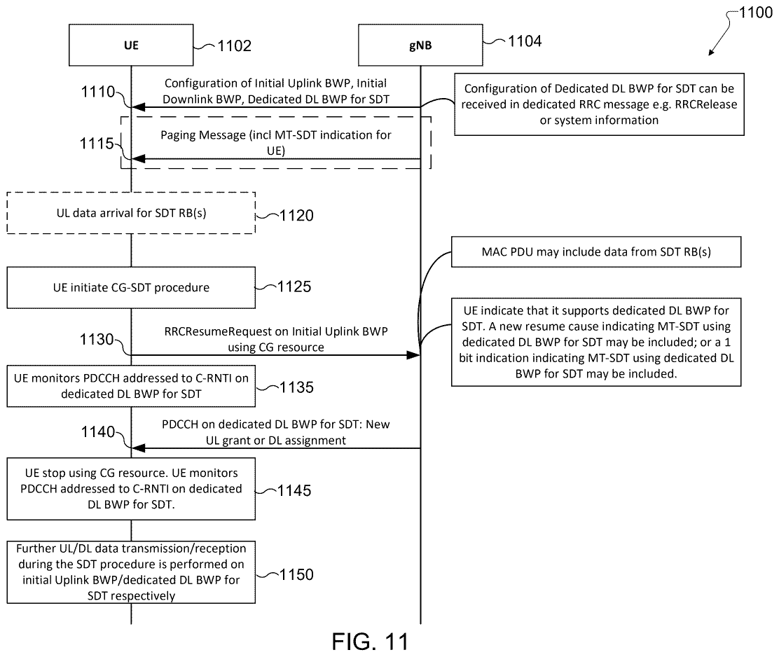

FIG. 11 illustrates another example of a small data transmission procedure in a cell 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIG. 11, a UE 1102 may be in an RRC_INACTIVE or RRC_IDLE state in a camped cell. At operation 1110, the UE 1002 receives a configuration of the initial uplink BWP, a configuration of the initial downlink BWP and a configuration of a dedicated DL BWP for SDT from a gNB 1104. The dedicated DL BWP for SDT may be for MT-SDT procedure, for MO-SDT procedure, or both. UE 1102 may receive the configuration of the initial uplink BWP and configuration of the initial downlink BWP from system information of the camped cell. UE 1102 may receive configuration of the dedicated downlink BWP for SDT from system information of the camped cell or from a dedicated signaling message (e.g., an RRCRelease message) received by UE 1102 from the gNB 1104. For example, the dedicated downlink BWP for a CG-SDT procedure can be received in a dedicated signaling message (e.g., an RRCRelease message) from gNB 1104, and a dedicated downlink BWP for an RA-SDT procedure can be received in system information of the camped cell.

At operation 1125, UE 1102 initiates a CG based SDT procedure. In some embodiments, UE 1102 may initiate the SDT procedure based on reception of a paging message including an MT-SDT indication for the UE 1102 at operation 1115. In some embodiments, UE 1102 may initiate the SDT procedure based on arrival of uplink data from upper layers for one or more SDT radio bearer(s) at operation 1120.

At operation 1130, UE 1102 transmits an RRC Resume Request/RRC Resume Request 1 to gNB 1104 on the initial uplink BWP using a CG resource. This may also be referred to as an initial uplink transmission or initial uplink transmission including CCCH message/SDU. A MAC PDU transmitted in the CG resource may include data from one or more SDT RB(s) in addition to the RRC Resume Request/RRC Resume Request 1. In some embodiments, UE 1102 may indicate in the MAC PDU (or RRCResume Request/RRCResume request 1) that UE 1102 supports dedicated DL BWP for SDT (or MT-SDT). A new resume cause indicating MT-SDT using dedicated DL BWP for SDT may be included, or a 1 bit indication indicating MT-SDT (or SDT) using dedicated DL BWP may be included, or a 1 bit indication indicating that UE supports dedicated DL BWP for SDT (or MT-SDT) may be included, or a reserved LCID/ELCID to indicate that UE supports dedicated DL BWP for SDT (or MT-SDT) can be used in the MAC PDU for RRCResume Request/RRCResume request 1. Alternatively, in some embodiments, UE 1102 may indicate to gNB 1104 that UE 1102 supports dedicated DL BWP for SDT (or MT-SDT) or UE 1102 may indicate in an RRC_CONNECTED state that UE 1102 supports dedicated BWP for SDT (or MT-SDT) using an RRC message.

In some embodiments, UE 1102 may indicate in the MAC PDU (or RRCResume Request/RRCResume request 1) that UE 1102 supports initial DL BWP without CORESET 0 restriction for SDT (or MT-SDT). A new resume cause indicating MT-SDT using the initial DL BWP without CORESET 0 restriction for SDT may be included, or a 1 bit indication indicating MT-SDT (or SDT) using the initial DL BWP without CORESET 0 restriction may be included, or a 1 bit indication indicating that UE 1102 supports initial DL BWP without CORESET 0 restriction for SDT (or MT-SDT) may be included, or a reserved LCID/ELCID to indicate that UE 1102 supports initial DL BWP without CORESET 0 restriction for SDT (or MT-SDT) can be used in the MAC PDU for RRCResume Request/RRCResume request 1. Alternatively, in some embodiments, UE 1102 may indicate to gNB 1104 that UE 1102 supports initial DL BWP without CORESET 0 restriction for SDT (or MT-SDT) or UE 1102 supports initial DL BWP without CORESET 0 restriction for SDT (or MT-SDT) in RRC_CONNECTED using an RRC message.

Alternatively, in some embodiments, UE 1102 may indicate to gNB 1104 that UE 1102 supports dedicated DL BWP for SDT (or MT-SDT) or UE 1102 supports dedicated BWP for SDT (or MT-SDT) in an RRC_CONNECTED state using an RRC message.

At operation 1135, UE 1102 monitors for a PDCCH addressed to a C-RNTI on the dedicated DL BWP for SDT to receive response from gNB 1104 for the initial uplink transmission including the RRC Resume Request/RRC Resume Request 1. At operation 1140, UE 1102 receives the PDCCH scheduling a new UL grant or new DL assignment on the dedicated DL BWP for SDT. Since gNB 1104 is aware of UE 1102's capability (based on the UE capability indicated in the RRC_CONNECTED state or the indication in the RRC Resume Request/RRC Resume Request 1 or LCID/eLCID used for the RRC Resume Request/RRC Resume Request 1 in the initial UL transmission) that UE 1102 supports dedicated BWP for SDT, gNB 1104 can transmit to UE 1102 in DL using the dedicated DL BWP.

In some embodiments, upon reception of the PDCCH scheduling a new UL grant or new DL assignment (this reception can also be referred to as an ACK for initial UL transmission), at operation 1145 UE 1102 stops using the CG resource, and UE 1102 monitors for a PDCCH addressed to a C-RNTI on the dedicated DL BWP for SDT. At operation 1150, further UL/DL data transmission/reception during the SDT procedure is performed on the initial Uplink BWP/dedicated DL BWP for SDT respectively.

Alternatively, in some embodiments, during the SDT procedure (after reception of the PDCCH scheduling a new UL grant or new DL assignment), UE 1102's active DL BWP can be switched between the initial DL BWP and the dedicated DL BWP for SDT by indication in DCI. Alternatively, in some embodiments, during the SDT procedure, UE 1102's active UL BWP can be switched between the initial UL BWP and dedicated UL BWP for SDT by indication in DCI.

In some embodiments, the initial downlink BWP and initial uplink BWP in the procedure of FIG. 11 are a redcap specific initial downlink BWP and a redcap specific initial uplink BWP.

In some embodiments, in the procedure of FIG. 11, the initial downlink BWP refers to the initial downlink BWP with CORESET 0 restriction (i.e., size/bandwidth/RBs of the initial downlink BWP is the same as size/bandwidth/RBs of CORESET 0) and the dedicated downlink BWP refers to the initial downlink BWP without CORESET 0 restriction (i.e., size/bandwidth/RBs of the initial downlink BWP is the same as size/bandwidth/RBs indicated by the locationAndBandwidth field in the BWP configuration of the initial downlink BWP).

Although FIG. 11 illustrates one example of a small data transmission procedure in a cell 1100, various changes may be made to FIG. 11. For example, while shown as a series of operations, various operations in FIG. 11 could overlap, occur in parallel, occur in a different order, occur any number of times, be omitted, or replaced by other operations.

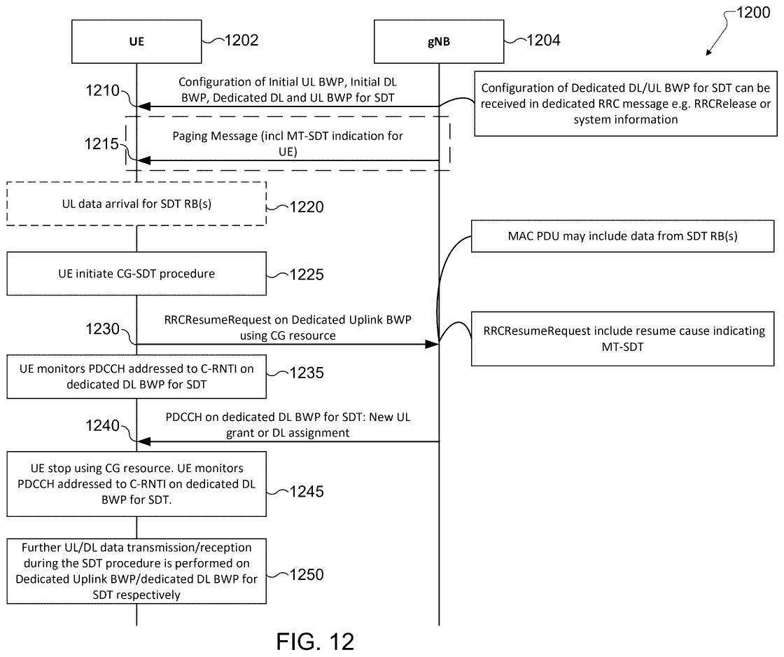

FIG. 12 illustrates another example of a small data transmission procedure in a cell 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIG. 12, a UE 1202 may be in an RRC_INACTIVE or RRC_IDLE state in a camped cell. At operation 1210, the UE 1202 receives a configuration of the initial uplink BWP, a configuration of the initial downlink BWP, a configuration of a dedicated UL BWP for SDT and a configuration of a dedicated DL BWP for SDT from a gNB 1204. The dedicated DL BWP for SDT and dedicated UL BWP for SDT may be for MT-SDT procedure, for MO-SDT procedure, or both. UE 1202 may receive the configuration of the initial uplink BWP and the configuration of the initial downlink BWP from system information of the camped cell. UE 1202 may receive the configuration of the dedicated downlink BWP for SDT and the dedicated UL BWP for SDT from system information of the camped cell or from a dedicated signaling message (e.g., and RRCRelease message) received by UE 1202 from the gNB 1204. For example, the dedicated downlink BWP and dedicated UL BWP for a CG-SDT procedure can be received in a dedicated signaling message (e.g., and RRCRelease message) from gNB 1204, and the dedicated downlink BWP and dedicated UL BWP for an RA-SDT procedure can be received in system information of the camped cell.

At operation 1225, UE 1202 initiates a CG based SDT procedure. In some embodiments, UE 1202 may initiate the SDT procedure based on reception of a paging message including an MT-SDT indication for the UE 1202 at operation 1215. In some embodiments, UE 1202 may initiate the SDT procedure based on arrival of uplink data from upper layers for one or more SDT radio bearer(s) at operation 1220.

UE 1202 selects the dedicated UL BWP for SDT and dedicated DL BWP for SDT. In some embodiments, if the SDT procedure is initiated based on a paging message and the paging message indicates for UE 1202 to use the dedicated UL BWP for SDT and the dedicated DL BWP for SDT, UE 1202 selects the dedicated UL BWP for SDT and the dedicated DL BWP for SDT. If the dedicated UL BWP for SDT is not configured, the initial uplink BWP is used in the procedure of FIG. 12 in place of the dedicated UL BWP for SDT. If the dedicated DL BWP for SDT is not configured, the initial downlink BWP is in the procedure of FIG. 12 in place of the dedicated DL BWP for SDT.

At operation 1230, UE 1202 transmits an RRC Resume Request/RRC Resume Request 1 to gNB 1204 on the dedicated uplink BWP for SDT using a CG resource. This transmission may also be referred to as an initial uplink transmission or initial uplink transmission including CCCH message/SDU. The MAC PDU transmitted in the CG resource may include data from one or more SDT RB(s) in addition to the RRC Resume Request/RRC Resume Request 1.

In some embodiments, the RRCResume Request/RRCResume request 1 may include a resume cause indicating MT-SDT if the SDT procedure is initiated based on a paging message. As the transmission is performed on the dedicated uplink BWP for SDT, an additional indication in the MAC PDU/RRC Resume Request/RRC Resume Request 1 indicating that the UE 1202 supports dedicated BWP for SDT is unnecessary. Reception of the initial uplink transmission in the dedicated uplink BWP for SDT indicates to gNB 1204 that UE 1202 supports dedicated BWP (UL and DL) for SDT.

At operation 1235, UE 1202 monitors for a PDCCH addressed to a C-RNTI on the dedicated DL BWP for SDT to receive a response from gNB 1204 for the initial uplink transmission including RRC Resume Request/RRC Resume Request 1. At operation 1240, UE 1202 receives the PDCCH scheduling a new UL grant or new DL assignment on the dedicated DL BWP for SDT. Since gNB 1204 is aware of UE 1202's capability that UE 1202 supports dedicated BWP for SDT, gNB 1204 can transmit to UE 1202 in DL using the dedicated DL BWP.

In some embodiments, upon reception of the PDCCH scheduling a new UL grant or new DL assignment (this reception can also be referred as an ACK for initial UL transmission), UE 1202 stops using the CG resource, and at operation 1245 UE 1202 monitors for a PDCCH addressed to a C-RNTI on the dedicated DL BWP for SDT. At operation 1250, further UL/DL data transmission/reception during the SDT procedure is performed on the initial uplink BWP/dedicated DL BWP for SDT respectively.

Alternatively, in some embodiments, during the SDT procedure (after reception of the PDCCH scheduling a new UL grant or new DL assignment), UE 1202's active DL BWP can be switched between the initial DL BWP and the dedicated DL BWP for SDT by indication in DCI. Alternatively, in some embodiments, during the SDT procedure, UE 1202's active UL BWP can be switched between the initial UL BWP and the dedicated UL BWP for SDT by indication in DCI.

In some embodiments, the initial downlink BWP and initial uplink BWP in the procedure of FIG. 12 are a redcap specific initial downlink BWP and a redcap specific initial uplink BWP.

In some embodiments, in the procedure of FIG. 12, the initial downlink BWP refers to the initial downlink BWP with CORESET 0 restriction (i.e., size/bandwidth/RBs of the initial downlink BWP is the same as size/bandwidth/RBs of CORESET 0) and the dedicated downlink BWP refers to the initial downlink BWP without CORESET 0 restriction (i.e., size/bandwidth/RBs of the initial downlink BWP is the same as size/bandwidth/RBs indicated by the locationAndBandwidth field in the BWP configuration of the initial downlink BWP).

Although FIG. 12 illustrates one example of a small data transmission procedure in a cell 1200, various changes may be made to FIG. 12. For example, while shown as a series of operations, various operations in FIG. 12 could overlap, occur in parallel, occur in a different order, occur any number of times, be omitted, or replaced by other operations.

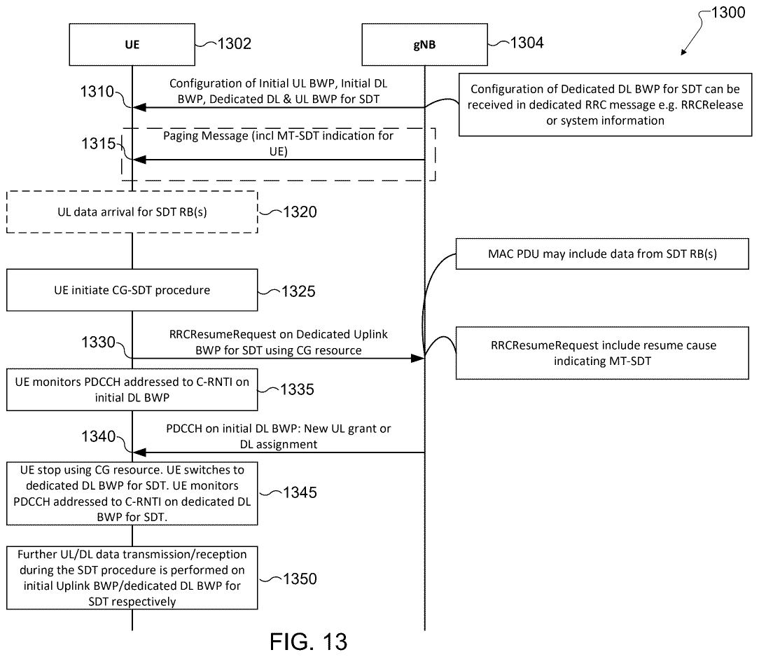

FIG. 13 illustrates another example of a small data transmission procedure in a cell 1300 according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a small data transmission procedure in a cell could be used without departing from the scope of this disclosure.

In the example of FIG. 13, a UE 1302 may be in an RRC_INACTIVE or RRC_IDLE state in a camped cell. At operation 1310, the UE 1302 receives a configuration of the initial uplink BWP, a configuration of the initial downlink BWP, a configuration of a dedicated UL BWP for SDT and a configuration of a dedicated DL BWP for SDT from a gNB 1304. The dedicated DL BWP for SDT and the dedicated UL BWP for SDT may be for MT-SDT procedure, for MO-SDT procedure, or both. UE 1302 may receive the configuration of the initial uplink BWP and the configuration of the initial downlink BWP from system information of the camped cell. UE 1302 may receive the configuration of the dedicated downlink BWP for SDT and the dedicated UL BWP for SDT from system information of the camped cell or from a dedicated signaling message (e.g., and RRCRelease message) received by UE 1302 from the gNB 1304. For example, the dedicated downlink BWP and dedicated UL BWP for a CG-SDT procedure can be received in a dedicated signaling message (e.g., RRCRelease message) from gNB 1302, and the dedicated downlink BWP and dedicated UL BWP for an RA-SDT procedure can be received in system information of the camped cell.

At operation 1325, UE 1302 initiates a CG based SDT procedure. In some embodiment, UE 1302 may initiate the SDT procedure based on reception of a paging message including an MT-SDT indication for the UE 1302 at operation 1315. In some embodiments, UE 1302 may initiate the SDT procedure based on arrival of uplink data from upper layers for one or more SDT radio bearer(s) at operation 1320.

UE 1302 selects the dedicated UL BWP for SDT and the initial downlink BWP. In some embodiments, if the SDT procedure is initiated based on a paging message and the paging message indicates for UE 1302 to use the dedicated UL BWP for SDT, UE 1302 selects the dedicated UL BWP for SDT. If the dedicated UL BWP for SDT is not configured, the initial uplink BWP is used in the procedure of FIG. 13 in place of the dedicated UL BWP for SDT.

At operation 1330, UE 1302 transmits and RRC Resume Request/RRC Resume Request 1 to gNB 1304 on the dedicated uplink BWP for SDT using a CG resource configured for SDT. This transmission may also be referred to as an initial uplink transmission or initial uplink transmission including CCCH message/SDU. The MAC PDU transmitted in the CG resource may include data from one or more SDT RB(s) in addition to RRC Resume Request/RRC Resume Request 1.

In some embodiments, the RRCResume Request/RRCResume request 1 may include a resume cause indicating MT-SDT if the SDT procedure is initiated based on a paging message. As the transmission is performed on the dedicated uplink BWP for SDT, additional indication in the MAC PDU/RRC Resume Request/RRC Resume Request 1 indicating that UE 1302 supports dedicated BWP for SDT is unnecessary. Reception of the initial uplink transmission in the dedicated uplink BWP for SDT indicates to gNB 1304 that UE 1302 supports dedicated BWP (UL and DL) for SDT.

At operation 1335, UE1302 monitors for a PDCCH addressed to a C-RNTI on the initial downlink BWP to receive a response from gNB 1304 for the initial uplink transmission including the RRC Resume Request/RRC Resume Request 1. At operation 1340, UE 1345 receives the PDCCH scheduling a new UL grant or new DL assignment on the initial downlink BWP.

In some embodiments, upon reception of the PDCCH scheduling a new UL grant or new DL assignment (this reception may also referred to as an ACK for initial UL transmission), at operation 1345 UE stops using the CG resource, and UE 1302 switches to the dedicated DL BWP for SDT and UE 1302 monitors for a PDCCH addressed to a C-RNTI on the dedicated DL BWP for SDT. At operation 1350, further UL/DL data transmission/reception during the SDT procedure is performed on the initial Uplink BWP/dedicated DL BWP for SDT respectively. Since gNB 1304 is aware of UE 1302's capability that UE 1302 supports dedicated BWP for SDT, gNB 1304 can transmit to UE 1302 in DL using the dedicated DL BWP.

Alternatively, in some embodiments, upon reception of the PDCCH scheduling a new UL grant or new DL assignment (this reception may also be referred to as an ACK for initial UL transmission), UE 1302 switches to the dedicated DL BWP for SDT and UE 1302 monitors for a PDCCH addressed to a C-RNTI on the dedicated DL BWP for SDT if the ongoing SDT procedure is triggered based on a paging message and if the paging message indicates for UE 1302 to switch to or use the dedicated DL BWP for SDT.

Alternatively, in some embodiments, upon reception of the PDCCH scheduling a new UL grant or new DL assignment (this reception may also referred to as an ACK for initial UL transmission), UE 1302 switches to a dedicated DL BWP for SDT and UE 1302 monitors for a PDCCH addressed to a C-RNTI on the dedicated DL BWP for SDT if the DCI of the received PDCCH scheduling a new UL grant or new DL assignment indicates for UE 1302 to switch to the dedicated DL BWP. Further UL/DL data transmission/reception during the SDT procedure is performed on the initial Uplink BWP/dedicated DL BWP for SDT respectively. Later gNB 1304 may switch the UE 1302 back to the initial DL BWP by indicating the initial DL BWP in DCI of a PDCCH addressed to a C-RNTI during the SDT procedure.

Alternatively, in some embodiments, upon reception of the PDCCH scheduling a new UL grant or new DL assignment (this reception may also referred to as an ACK for initial UL transmission), UE 1302 switches to the dedicated UL BWP for SDT. Alternatively, in some embodiments, during the SDT procedure, UE 1302 switches to the dedicated UL BWP if indicated by the DCI of PDCCH addressed to a C-RNTI. In some embodiments, upon reception of the PDCCH scheduling a new UL grant or new DL assignment (this reception may also be referred to as an ACK for initial UL transmission), during the SDT procedure UE 1302's active UL BWP can be switched between the initial UL BWP and dedicated UL BWP for SDT by indication in DCI.

In some embodiments, the initial downlink BWP and initial uplink BWP in the procedure of FIG. 13 are a redcap specific initial downlink BWP and a redcap specific initial uplink BWP.

In some embodiments in the procedure of FIG. 13, the initial downlink BWP refers to the initial downlink BWP with CORESET 0 restriction (i.e., size/bandwidth/RBs of the initial downlink BWP is the same as size/bandwidth/RBs of CORESET 0) and the dedicated downlink BWP refers to the initial downlink BWP without CORESET 0 restriction (i.e., size/bandwidth/RBs of the initial downlink BWP is the same as size/bandwidth/RBs indicated by the locationAndBandwidth field in the BWP configuration of the initial downlink BWP).

Although FIG. 13 illustrates one example of a small data transmission procedure in a cell 1300, various changes may be made to FIG. 13. For example, while shown as a series of operations, various operations in FIG. 13 could overlap, occur in parallel, occur in a different order, occur any number of times, be omitted, or replaced by other operations.

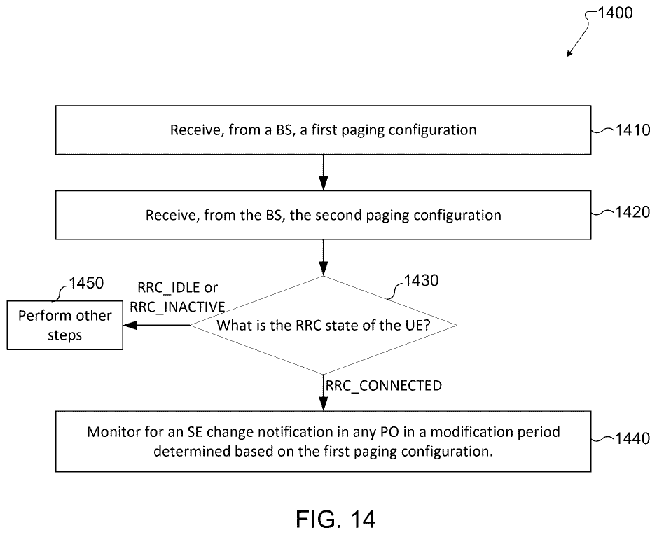

FIG. 14 illustrates an example method for transmitting and receiving SI change notifications 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for transmitting and receiving SI change notifications could be used without departing from the scope of this disclosure.

In the example of FIG. 14, a UE (such as UE 116 of FIG. 1) receives, from a BS (such as gNB 102 of FIG. 1), a first paging configuration. In some embodiments, the first paging configuration may include a first configuration of one or more of a number of paging frames (N), a number of POs (Ns), a first paging frame offset, and a parameter firstPDCCH-MonitoringOccassionOfPO. In some embodiments, the second paging configuration may be for paging adaptation.

At step 1420, the UE receives, from the BS, a second paging configuration. In some embodiments, the second paging configuration may include a second configuration of one or more of the number of paging frames (N), the number of POs (Ns), the first paging frame offset, and the parameter firstPDCCH-MonitoringOccassionOfPO.

At step 1430, the UE determines an RRC state of the UE. in response to a determination that the RRC state of the UE is RRC_CONNECTED, the method proceeds to step 1440. Otherwise, in response to a determination that the RRC state of the UE is RRC_IDLE or RRC_INACTIVE, the method proceeds to step 1450.

At step 1440, the UE monitors for an SI change notification in any PO in a modification period. The PO in the modification period is determined based on the first paging configuration.

At step 1450, in response to a determination that the RRC state of the UE is RRC_IDLE or RRC_INACTIVE, the UE performs other steps. For example, in some embodiments, the UE may monitor for an SI change notification in a PO designated for the UE. In embodiments such as these, the PO designated for the UE may be determined based on the second paging configuration.

In some embodiments, the UE may monitor for a PWS notification. For example, in some embodiments, in response to a determination that the RRC state of the UE is RRC_CONNECTED (for example, at step 1430), the UE may monitor for the PWS notification in any PO in a default paging cycle. In embodiment such as these, the PO in the default paging cycle may be determined based on the first paging configuration. In another example, in some embodiments, in response to a determination that the RRC state of the UE is RRC_IDLE or RRC_INACTIVE (for example, at step 1430), the UE may monitor for the PWS notification in a PO designated for the UE. In embodiments such as these, the PO designated for the UE may be determined based on the second paging configuration.

Although FIG. 14 illustrates one example method for transmitting and receiving SI change notifications 1400, various changes may be made to FIG. 14. For example, while shown as a series of steps, various steps in FIG. 14 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS), a first paging configuration; and
receive, from the BS, a second paging configuration; and
a processor operably coupled to the transceiver, the processor configured to:
determine a radio resource control (RRC) state of the UE; and
in response to a determination that the RRC state of the UE is RRC_CONNECTED, monitor for a system information (SI) change notification in any paging occasion (PO) in a modification period,
wherein the PO in the modification period is determined based on the first paging configuration.

2. The UE of claim 1, wherein:
the processor is further configured to, in response to a determination that the RRC state of the UE is RRC_IDLE or RRC_INACTIVE, monitor for an SI change notification in a PO designated for the UE; and
the PO designated for the UE is determined based on the second paging configuration.

3. The UE of claim 1, wherein the processor is further configured to monitor for a public warning system (PWS) notification.

4. The UE of claim 3, wherein:
the processor is further configured to, in response to a determination that the RRC state of the UE is RRC_CONNECTED, monitor for the PWS notification in any PO in a default paging cycle; and
the PO in the default paging cycle is determined based on the first paging configuration.

5. The UE of claim 3, wherein:
the processor is further configured to, in response to a determination that the RRC state of the UE is RRC_IDLE or RRC_INACTIVE, monitor for the PWS notification in a PO designated for the UE; and
the PO designated for the UE is determined based on the second paging configuration.

6. The UE of claim 1, wherein:
the first paging configuration includes a first configuration of one or more of:
a number of paging frames (N);
a number of POs (Ns);
a first paging frame offset; and
a parameter firstPDCCH-MonitoringOccassionOfPO; and
the second paging configuration includes a second configuration of one or more of:
the number of paging frames (N);
the number of POs (Ns);
the first paging frame offset; and
the parameter firstPDCCH-MonitoringOccassionOfPO.

7. The UE of claim 1, wherein the second paging configuration is for paging adaptation.

8. A method of operating a user equipment (UE), the method comprising:
receiving, from a base station (BS), a first paging configuration;
receiving, from the BS, a second paging configuration;
determining a radio resource control (RRC) state of the UE; and
in response to a determination that the RRC state of the UE is RRC_CONNECTED, monitoring for a system information (SI) change notification in any paging occasion (PO) in a modification period,
wherein the PO in the modification period is determined based on the first paging configuration.

9. The method of claim 8, further comprising:
in response to a determination that the RRC state of the UE is RRC_IDLE or RRC_INACTIVE, monitoring for an SI change notification in a PO designated for the UE,
wherein the PO designated for the UE is determined based on the second paging configuration.

10. The method of claim 8, further comprising monitoring for a public warning system (PWS) notification.

11. The method of claim 10, further comprising:
in response to a determination that the RRC state of the UE is RRC_CONNECTED, monitoring for the PWS notification in any PO in a default paging cycle,
wherein the PO in the default paging cycle is determined based on the first paging configuration.

12. The method of claim 10, further comprising:
in response to a determination that the RRC state of the UE is RRC_IDLE or RRC_INACTIVE, monitoring for the PWS notification in a PO designated for the UE,
wherein the PO designated for the UE is determined based on the second paging configuration.

13. The method of claim 8, wherein:
the first paging configuration includes a first configuration of one or more of:
a number of paging frames (N);
a number of POs (Ns);
a first paging frame offset; and
a parameter firstPDCCH-MonitoringOccassionOfPO; and
the second paging configuration includes a second configuration of one or more of:
the number of paging frames (N);
the number of POs (Ns);
the first paging frame offset; and
the parameter firstPDCCH-MonitoringOccassionOfPO.

14. The method of claim 8, wherein the second paging configuration is for paging adaptation.

15. A non-transitory computer readable medium embodying a computer program comprising program code that, when executed by a processor of a device, causes the device to:
receive, from a base station (BS), a first paging configuration;
receive, from the BS, a second paging configuration;
determine a radio resource control (RRC) state of the device; and
in response to a determination that the RRC state of the device is RRC_CONNECTED, monitor for a system information (SI) change notification in any paging occasion (PO) in a modification period,
wherein the PO in the modification period is determined based on the first paging configuration.

16. The non-transitory computer readable medium of claim 15, wherein the program code, when executed by the processor of the device, further causes the device to:
in response to a determination that the RRC state of the device is RRC_IDLE or RRC_INACTIVE, monitoring for an SI change notification in a PO designated for the device,
wherein the PO designated for the device is determined based on the second paging configuration.

17. The non-transitory computer readable medium of claim 15, wherein the program code, when executed by the processor of the device, further causes the device to:
in response to a determination that the RRC state of the device is RRC_CONNECTED, monitoring for a public warning system (PWS) notification in any PO in a default paging cycle,
wherein the PO in the default paging cycle is determined based on the first paging configuration.

18. The non-transitory computer readable medium of claim 15, wherein the program code, when executed by the processor of the device, further causes the device to:
in response to a determination that the RRC state of the device is RRC_IDLE or RRC_INACTIVE, monitoring for a public warning system (PWS) notification in a PO designated for the device,
wherein the PO designated for the device is determined based on the second paging configuration.

19. The non-transitory computer readable medium of claim 15, wherein:
the first paging configuration includes a first configuration of one or more of:
a number of paging frames (N);
a number of POs (Ns);
a first paging frame offset; and
a parameter firstPDCCH-MonitoringOccassionOfPO; and
the second paging configuration includes a second configuration of one or more of:
the number of paging frames (N);
the number of POs (Ns);
the first paging frame offset; and
the parameter firstPDCCH-MonitoringOccassionOfPO.

20. The non-transitory computer readable medium of claim 15, wherein the second paging configuration is for paging adaptation.
